(19) United States
(12) Patent Application Publication
(10) Pub. No.: US 2003/0116641 A1
(43) Pub. Date: Jun. 26, 2003

(54) Liquid injection apparatus

(75) Inventors: Takao Ohnishi, Nishibiwajima-town (JP); Toshikazu Hirota, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/263,326

(22) Filed: Oct. 2, 2002

Related U.S. Application Data
(60) Provisional application No. 60/396,766, filed on Jul. 18, 2002.

(30) Foreign Application Priority Data
Oct. 2, 2001 (JP) 2001-306385
Nov. 16, 2001 (JP) 2001-352166
Mar. 12, 2002 (JP) 2002-067216

(51) Int. Cl. B05B 1/08

(52) U.S. Cl. 239/102.1

(57) ABSTRACT

A liquid injection apparatus is provided which is capable of uniformly atomizing and injecting liquid such as fuel even if the surrounding environment changes significantly.

A liquid injection apparatus 10 comprises an injection unit 14 fixed to a liquid injection space 21 defined by, e.g., a suction pipe 20 of an internal combustion engine, and a pressurizing pump 11 for pressurizing liquid from a liquid storage tank 22 up to a pressure to supply the liquid to the injection unit and to inject the liquid into the space. The injection unit comprises, in order to atomize the liquid supplied by the pressurizing pump, a plurality of chambers in which a piezoelectric/electrostrictive element is formed at least on its wall surface, and a plurality of liquid ejection nozzles. Vibration energy induced by the piezoelectric/electrostrictive element is given to the pressurized liquid in the chamber of the injection unit, and the liquid is atomized and injected into the liquid injection space from the extremity of the liquid ejection nozzle.

### BACKGROUND OF THE INVENTION

1. Field of the Invention

The present invention relates to a liquid injection apparatus for application in various types of machines that utilize liquid materials, fuel and the like injected into a liquid injection space, and for atomizing and injecting liquid into the liquid injection space, and to a method of adjusting the resonance frequency of an injection unit included in the liquid injection apparatus.

2. Description of the Related Art

As a liquid injection apparatus of this kind, a fuel injection apparatus for an internal combustion engine has been known. The fuel injection apparatus for an internal combustion engine is what is called an electrically controlled fuel injection apparatus that has a pressurizing pump for pressurizing liquid, and an electromagnetic injection valve, and is widely in practical use. However, in the electrically controlled fuel injection apparatus, since fuel pressurized by the pressurizing pump is injected from an injection port of the electromagnetic injection valve, the size of liquid droplets of the injected fuel is, generally, about 100 μm at the minimum, which is relatively large, and the size is not uniform. Such a size of liquid droplets of the fuel and the uniformity of the size increase unburnt fuel at the time of combustion, and further lead to the increase of undesirable exhaust gas.

On the other hand, as disclosed in Japanese Patent Application Laid-open (kokai) No. 54-90416, a liquid droplet ejecting apparatus is proposed in which liquid in a liquid supply passage is pressurized by the actuation of a piezoelectrostrictive element and the liquid is ejected as micro liquid droplets from the eject port. Such an apparatus utilizes the principle of an ink jet eject apparatus disclosed in, for example, Japanese Patent Application Laid-open (kokai) No. 6-40030, and is thus capable of making the ejected liquid droplets (liquid droplets of injected fuel) small and uniform as compared with the electrically controlled fuel injection apparatus, and therefore this apparatus can be considered to be an excellent apparatus in terms of fuel atomization.

When the ink jet eject apparatus is used in a relatively stationary surrounding environment with little change in temperature, pressure or the like (e.g., in the rooms of offices, schools and the like), the apparatus is capable of attaining expected performance of injecting liquid as micro particles. However, when used in a surrounding environment that changes severely in accordance with the changes in operating conditions or the like, as in the internal combustion engine, it is generally difficult for the apparatus to sufficiently achieve the performance of atomizing fuel. Therefore, in the present situation, such a liquid (fuel) injection apparatus has not been provided yet that utilizes the principle of the ink jet eject apparatus and is capable of injecting liquid with sufficiently achieving the atomization of the liquid, for use in the mechanical apparatus such as the internal combustion engine used in the surrounding environment which changes severely.

### SUMMARY OF THE INVENTION

It is therefore an object of the present invention to provide a liquid injection apparatus capable of stably atomizing and injecting liquid, wherein liquid droplets are small and their size is uniform. It is another object of the invention to provide a liquid injection apparatus comprising a structure capable of stably injecting liquid even under conditions that the environment including a liquid injection space in which the liquid injection apparatus is used changes severely and abruptly.

In order to attain the above objects, according to a first aspect of the present invention there is provided a liquid injection apparatus comprising an injection unit which comprises a flow passage forming section, the flow passage forming section including a liquid ejection nozzle having one end exposed to a liquid injection space and a chamber which communicates with the other end of the liquid ejection nozzle and with one end of a first liquid supply pipe; drive voltage generating means for generating a drive voltage signal having a predetermined frequency; and pressurizing means having an ejection section to which is connected the other end of the first liquid supply pipe, the pressurizing means having an introduction section in communication with a liquid storage tank, the pressurizing means pressurizing liquid introduced through the introduction section from the liquid storage tank to eject the liquid from the ejection section, to thereby inject the liquid into the liquid injection space through the liquid ejection nozzle of the liquid injection unit; wherein the injection unit comprises a plurality of the liquid ejection nozzles, the injection unit having a pressurizing section which includes a piezoelectric/electrostrictive element positioned at part of a wall surface of the chamber for changing the capacity of the chamber, the piezoelectric/electrostrictive element being actuated by the drive voltage signal from the drive voltage generating means to atomize the liquid injected from the liquid ejection nozzle. It will be appreciated that to “communicate” means to be directly or indirectly connected. In the present specification, a “pipe” is used synonymously with a “passage”.

By this apparatus, liquid pressurized by pressurizing means is injected from a plurality of liquid ejection nozzles, so that even if air bubbles are generated in the liquid, the air bubbles are divided into minute pieces. As a result, it is possible to avoid substantial changes in the amount of injection caused by the presence of the air bubbles. Further, since the actuation of the piezoelectric/electrostrictive element changes the capacity of chambers, which gives vibration energy (this can also be referred to simply as “vibrations”.) to the liquid to be injected, the liquid is injected as liquid droplets in the form of fine particles from the liquid ejection nozzles.

In this case, the size of the liquid droplets in the form of fine particles varies depending upon physicalities such as the pressure applied to the liquid, the amplitude and frequency of vibrations of the piezoelectric/electrostrictive element, the shape of a flow passage, the size of the flow passage, and the viscosity (consistency) and surface tension of the liquid. If a period of vibrations added to liquid is shorter than the time in which, in the vicinity of an end portion (an opening exposed to the liquid injection space) of the liquid ejection nozzle inside this nozzle, the liquid moves by a distance equivalent to the diameter of the end portion of the nozzle, the size of the liquid droplets to be injected is approximately smaller than the diameter of the end portion of the liquid ejection nozzle. Therefore, for example, if the diameter of the end portion (opening), which is exposed to the liquid injection space, of the liquid ejection nozzle is designed to be several tens of μm or less, the liquid injection apparatus can inject liquid droplets that are made minute in a significantly uniform state. For example, when used as a fuel injection apparatus for an internal combustion engine, the apparatus can form the fuel to be injected into fine particles of liquid droplets having an appropriate diameter, thereby accomplishing improvement in the fuel consumption of the internal combustion engine and a reduction of undesirable exhaust gas.

Furthermore, according to such a configuration (composition), the pressure necessary for the injection of liquid is generated by the pressurizing means, and if the environment (e.g., pressure and temperature) in the liquid injection space changes severely due to changes of operating conditions and the like of a machine to which the liquid injection apparatus is applied, it is still possible to stably inject and supply the liquid in the form of desired micro particles.

Still further, in conventional carburetors, the flow volume of fuel (liquid) is determined in accordance with air current velocity (air flow speed) in a space inside a suction pipe, which gives a liquid droplet eject space (liquid injection space), and the degree of atomization is changed depending upon the air current velocity. However, in the liquid injection apparatus of the present invention, it is possible to eject fuel (liquid) maintaining a favorable atomization state as much as required, regardless of the air current velocity. In addition, the liquid injection apparatus in accordance with the present invention does not have to require a compressor for supplying assist air, unlike conventional apparatuses that encourage the atomization of fuel by supplying assist air to a nozzle section of a fuel injector, thereby making the apparatus inexpensive.

Herein, as in the invention defined in claim 2, it is preferred that the liquid injection apparatus further comprise an injection valve including a liquid injection opening exposed to the liquid injection space, a liquid passage communicating with the liquid injection opening, and an electromagnetic valve for opening and closing the liquid passage; and a second liquid supply pipe for placing the liquid passage of the injection valve in communication with the ejection section of the pressurizing means.

Thus, liquid can be injected through the second liquid supply pipe and the injection valve that provides a different course (passage, system) than one which passes through the first liquid supply pipe and the injection unit, so that a great volume of liquid can be injected as required.

Further, As in the invention defined in claim 3, it is preferred that the liquid injection apparatus further comprise a regulator which is interposed in the first liquid supply pipe, for reducing the pressure of liquid generated by the pressurizing means.

The liquid injection apparatus employing the injection unit forms liquid into fine particles by the actuation of the piezoelectric/electrostrictive element, and thus does not need high pressure to form the liquid into fine particles, therefore, the pressure that the pressurizing means is required to generate is naturally low. In other words, as the pressurizing means, it is possible to employ, for example, an inexpensive low-pressure pump that generates pressure of less than several atmospheres. However, as in the invention in accordance with claim 2 above, when the liquid is injected from the liquid supply path under the different system (passage) passing via the injection valve (i.e., when an apparatus such as what is called an electrically controlled fuel injection apparatus is additionally set), it is necessary to use a high-pressure pump that generates relatively high pressure as the pressurizing means in order to form the liquid injected from the injection valve into fine particles. At this point, if the composition is such that the pressure of the liquid generated by the pressurizing means is reduced by the regulator, as in the invention according to claim 3, it is not necessary to additionally employ the low-pressure pump, thereby making it possible to decrease the cost of the liquid injection apparatus.

In any of the above liquid injection apparatuses, as in the invention defined in claim 4, the ratio of the capacity of the chamber to the variation of the capacity of the chamber (i.e. the amount of capacity change) caused by the operation of the piezoelectric/electrostrictive element is preferably a value ranging from 2 to 3000 inclusive.

This is because, if the ratio (chamber capacity/capacity variation) is beyond 3000, the energy amount of vibrations transmitted to the liquid inside the chamber is too small, making it impossible to sufficiently form the liquid into fine particles, and if the ratio (chamber capacity/capacity variation) is two or less, the pressure of the liquid in the chamber changes significantly, thus making a eject amount (injection flow volume) unstable, and if the liquid is volatile as gasoline fuel, stable injection might be impossible because a large quantity of the air bubbles is generated in the liquid. More preferably, the ratio (chamber capacity/capacity variation) is two or more and 1500 or less.

In any of the above liquid injection apparatuses, as in the invention defined in claim 5, it is preferred that the chamber include a flow passage section through which the liquid flows from the side of the first liquid supply pipe toward the side of the liquid ejection nozzle, the shape of a section of the flow passage section taken along a plane orthogonal to the direction of flow of the liquid (in the flow passage section) is being substantially rectangular, and that the piezoelectric/electrostrictive element be fixed in at least a part of the wall surface of the chamber that includes at least one side of the rectangle, with the ratio of the length of a side orthogonal to the one side to the length of the one side being less than 1.

In any of the above liquid injection apparatuses, as the invention according to claim 6, it is preferred that the chamber include a flow passage section which communicates, at one end portion, with one end of the first liquid supply pipe via a liquid introduction hole, the flow passage section being connected, at the other end portion, to the other end of the liquid ejection nozzle such that the liquid flows from the one end portion toward the other end portion, and that the area of the section of the flow passage section taken along the plane orthogonal to the direction of flow of the liquid be larger than the cross section area of the liquid introduction hole and than the cross section area at one end exposed to the liquid injection space of the liquid ejection nozzle.

If the chamber is constituted as described above, it is possible not only to efficiently transmit the energy of vibrations by the piezoelectric/electrostrictive element to the liquid flowing in the chamber, but also to transmit the energy of the vibrations to the entire liquid, thereby ensuring the liquid to be atomized regardless of the kind of liquid.

As in the invention defined in claim 7, the cross section area at one end exposed to the liquid injection space of the liquid ejection nozzle is preferably larger than the cross section area of the liquid introduction hole.

According to the above configuration, it is unlikely that the vibration energy of the piezoelectric/electrostrictive element added to the liquid in the chamber is transmitted to liquid in the first liquid supply pipe via the liquid introduction hole and is damped in the first liquid supply pipe. Therefore, the vibration energy is efficiently transmitted to the liquid ejected from one end of the liquid ejection nozzle, thereby ensuring the liquid to be atomized.

As to the arrangement and composition of the chamber and/or the piezoelectric/electrostrictive element described above, it should be easily understood that their effects can be obtained even if each of them is employed independently, however, using these in combination provides more effects.

As in the invention defined in claim 8, it is preferred that the injection unit comprise an electromagnetic open-close valve having a liquid passage and an electromagnetic valve for opening and closing the liquid passage, the electromagnetic open-close valve being disposed to place one end of the first liquid supply pipe in communication with the chamber by way of the liquid passage, and the liquid is injected from the liquid ejection nozzle when the electromagnetic valve of the electromagnetic open-close valve is opened.

Thus, for example, by controlling the electromagnetic open-close valve such as an electromagnetic fuel injection valve that has conventionally been widely adopted in the fuel injection apparatus for an internal combustion engine, it is possible to finely control the amount of injection from the injection unit. Therefore, for example, when the liquid injection apparatus having such a composition is used as the fuel injection apparatus for an internal combustion engine, the injection amount is precisely controlled in addition to the atomization of the liquid, thereby further ensuring improvement in the fuel consumption of the internal combustion engine and a reduction of undesirable exhaust gas from the internal combustion engine.

As in the invention defined in claim 9, any of the above liquid injection apparatus preferably further comprises an electromagnetic open-close valve which is interposed in the first liquid supply pipe, for opening and closing the flow passage of the fist liquid supply pipe; and a bypass pipe which makes the liquid storage tank communicate with the fist liquid supply pipe at between the electromagnetic open-close valve of the fist liquid supply pipe and the ejection section of the pressurizing means, in parallel with the pressurizing means, the bypass pipe having a check valve interposed therein for permitting liquid to flow from the fist liquid supply pipe to the liquid storage tank, only when the pressure of the liquid in the fist liquid supply pipe at between the electromagnetic open-close valve and the ejection section of the pressurizing means is beyond a predetermined value.

Thus, it is possible to finely control the amount of injection from the injection unit by controlling the electromagnetic open-close valve, so that, synergistically with the effects of forming liquid into fine particles, for example, when the liquid injection apparatus having such a composition is used as the fuel injection apparatus for an internal combustion engine, improvement in the fuel consumption and a reduction of undesirable exhaust gas can be further ensured. Further, when the pressure of the liquid in the first liquid supply passage increases beyond a predetermined pressure, the bypass pipe returns the liquid to the liquid storage tank to enable the pressure to be decreased to the predetermined pressure or less, thereby making it possible to prevent breakage of the apparatus, unnecessary liquid leakage and the like.

As in the invention defined in claim 10, the flow passage forming section of the injection unit of any of the above liquid injection apparatuses is preferably formed of zirconia ceramics. In addition, the flow passage forming section of the injection unit and the piezoelectric/electrostrictive element of the pressurizing section are preferably integrally formed by burning.

According to the feature described above, owing to the characteristics of zirconia ceramics, it is possible to provide the injection unit that comprises the flow passage forming section capable of maintaining high durability against frequent deformation of a wall surface caused by the piezoelectric/electrostrictive element, and that has a plurality of liquid ejection nozzles, in such a small size, with a full length of several centimeters. Further, the flow passage forming section can be formed easily by integrally burning the ceramics, and the pressurizing section, which includes the piezoelectric/electrostrictive element, can be joined easily and firmly to the flow passage forming section by burning, thereby securely ensuring the transmission of the force generated by the pressurizing section to the chamber.

As in the invention defined in claim 11, in the injection unit of any of the above liquid injection apparatuses, it is preferable that the flow passage forming section and the pressurizing section are made as separate members, and the piezoelectric/electrostrictive element of the pressurizing section is bonded to the flow passage forming section (without burning).

According to the feature described above, since the flow passage forming section and the piezoelectric/electrostrictive element of the pressurizing section are not burnt integrally, it is possible to have a wider range for selecting materials for a member (diaphragm) that constitutes the wall surface of the flow passage forming section, especially of the chamber. More specifically, the wall surface member of the chamber can be formed not only of ceramics such as zirconia, but also of materials other than ceramics, and therefore, for example, if the wall surface of the chamber is formed of a metallic material having good tenacity, durability of the injection unit can be improved. Further, the material of the piezoelectric/electrostrictive element, which is included in the pressurizing section, does not permeate by burning into the wall (surface) of the chamber, which is part of the flow passage forming section, and therefore does not decrease the tenacity of the injection unit. Thus, if the wall surface member of the chamber is constituted of ceramics, the injection unit having excellent durability can be provided. Examples of materials for the flow passage forming section besides ceramics would include iron materials such as stainless steels of various kinds (SUS) or spring steel products of various kinds, and non-iron materials such as beryllium copper, phosphor bronze, nickel and a nickel iron alloy.

As described hereinabove, in case of the liquid injection apparatus having the piezoelectric/electrostrictive element bonded to the flow passage forming section, as in the invention defined in claim 12, the pressurizing section preferably presses the wall surface of the chamber in the flow passage forming section to change the capacity of the chamber.

Thus, since the pressing force of the piezoelectric/electrostrictive element deforms the wall surface of the chamber, the capacity of the chamber can certainly be changed for a long period of time regardless of the adhesion strength between the piezoelectric/electrostrictive element and the flow passage forming section, thereby making it possible to provide the liquid injection apparatus with excellent durability.

As in the invention defined in claim 13, it is preferred that the pressurizing section include a plate made of ceramics which has the rigidity higher than that of the chamber wall (chamber upper wall) pressed by the pressurizing section and which is immovably fixed to the flow passage forming section apart a predetermined distance from the wall surface of the chambers (when the chamber wall is not deformed by the pressurizing section), and that the piezoelectric/electrostrictive element be formed in a shape of a thin plate (a layer, a laminate), and at one surface, be integrally joined by burning to the ceramic plate, and at the other surface, be bonded to the chamber wall surface pressed by the pressurizing section.

According to this aspect, the piezoelectric/electrostrictive element joined integrally to the ceramic plate by burning repeatedly presses the wall (wall surface on which the piezoelectric/electrostrictive element is formed) of the chamber that functions as the diaphragm, thereby adding vibrations to the liquid in the chamber to form the liquid to be injected into fine particles. Here, since parts that are substantially relating to the vibrations caused by the piezoelectric/electrostrictive element include the chamber, the wall (surface) of the chamber, the piezoelectric/electrostrictive element and the ceramic plate, and the rigidity of the ceramic plate is high, resonance frequency of a part constituted of these parts is increased.

Incidentally, in general, if the wall (wall surface) of the chamber functioning as the diaphragm is vibrated at a frequency lower than the resonance frequency, the wall of the chamber functioning as the diaphragm is deformed only from a nodal line (line of intersection) of (between) the wall and other walls (wall surfaces) of the chamber. That is, a node of the vibrations of the wall is the nodal line (the wall (wall surface) functioning as the diaphragm is deformed to have a single abdomen). Thus, it is possible to ensure that the vibrations necessary to inject the liquid as fine particles having a desired particle diameter are added to the liquid.

Contrary to this, if the wall (surface) of the chamber functioning as the diaphragm is vibrated by the piezoelectric/electrostrictive element at a frequency higher than the resonance frequency of the parts substantially relating to the vibrations, the wall (surface) is deformed to have a plurality of wave fronts, and it will be difficult to add to the liquid the vibrations for forming the injected liquid into the fine particles having a desired small particle diameter.

Therefore, it is apparent that, according to the configuration of the present invention described above, it is possible to certainly form the liquid into fine particles even if the wall (surface) of the chamber is vibrated at a higher frequency, since the resonance frequency of the parts substantially relating to the vibrations caused by the piezoelectric/electrostrictive element is increased. Thus, it is possible to make the particle diameter of the injected liquid become smaller. Alternatively, even when the pressure generated by the pressurizing means is heightened to increase the injection amount per unit time, the liquid is certainly atomized by vibrating the wall (surface) of the chamber at the higher frequency up to the increased high frequency (the increased resonance frequency) mentioned above. Thus, it is possible to supply large amount (quantities) of liquid droplets which is atomized.

As in the invention defined in claim 14, the pressurizing section is preferably comprised of a layer which includes a multiplicity of alternating laminal piezoelectric/electrostrictive elements and laminal electrodes.

Thus, the force (deforming force, pressurizing force) of the pressurizing section to deform the wall (surface) of the chamber can be increased even at (with) a low voltage. In other words, the displacement amount of the wall surface of the chamber (capacity variation of the chamber) can be increased. Thus, the aspect of the present invention described above can decrease the power consumption of the liquid injection apparatus. Further, even if the width and/or length of the wall (surface) of the chamber comprising the piezoelectric/electrostrictive element are/is reduced and the rigidity of the wall (surface) is increased so that the wall surface becomes hard to be deformed, the wall surface of the chamber can be deformed as much as desired and the desirable capacity variation of the chamber can be ensured, since the force to deform the wall (surface) of the chamber can be made large enough. Therefore, since the liquid to be injected can be pressurized in a manner that it can be atomized even if the width and/or length of the wall (surface) of the chamber are/is reduced, the injection unit can be miniaturized.

As in the invention defined in claim 15, it is preferred that the chamber be connected to one end of the first liquid supply pipe via the liquid introduction hole, and that the drive voltage generating means increase the voltage of the drive voltage signal up to a predetermined voltage to decrease the capacity of the chamber so that the pressure of liquid in the chamber and in the liquid introduction hole is increased, then maintain the voltage at the predetermined voltage until the pressure of the liquid in the liquid introduction hole substantially drops down to the pressure generated by the pressurizing means, and then decrease the voltage.

As the liquid injection apparatus of the present invention comprises the piezoelectric/electrostrictive element and the pressurizing means capable of pressurizing liquid, both the pressure increase caused by the piezoelectric/electrostrictive element and the pressure increase caused by the pressurizing means are superposed in the liquid introduction hole immediately after the pressurizing operation of the piezoelectric/electrostrictive element, and thus the pressure of the liquid in the liquid introduction hole (section) is significantly increased. Therefore, if the voltage of the drive voltage signal starts to be decreased immediately after this state (i.e. interposing both pressure) is obtained, pressure change of the liquid in the liquid introduction hole is so rapid that the air bubbles might be generated. On the other hand, as described above, if the voltage is kept at the predetermined voltage until the pressure of the liquid in the liquid introduction hole substantially lowers down to the pressure generated by (only) the pressurizing means after the pressure of the liquid in the chamber and in the liquid introduction hole is increased by increasing the voltage of the drive voltage signal given to the piezoelectric/electrostrictive element to a predetermined voltage as described above, and if the voltage is started to be decreased after the pressure of the liquid in the liquid introduction hole substantially lowers down to the pressure generated by the pressurizing means, the pressure in the liquid introduction hole does not change abruptly so that the air bubbles are not generated, thereby making it possible to inject the liquid stably.

As in the invention defined in claim 16, the liquid injection apparatus is preferably configured such that a frequency of the drive voltage signal is substantially equal to a resonance frequency of the injection unit.

According to this aspect, since the wall (surface) of the injection unit can be greatly vibrated with a little energy, the power consumption of the liquid injection apparatus can be reduced.

As in the invention defined in claim 17, the injection unit preferably comprises a plurality of the chambers, at least one of the plurality of chambers comprising a plurality of liquid ejection nozzles.

According to this aspect, it is possible to provide the liquid injection apparatus capable of injecting a large amount of liquid droplets having a uniform and minute particle diameter at a time, without changing (increasing) the size of the injection unit.

As in the invention according to claim 18, the shape of the liquid injection opening which is one end of the liquid ejection nozzle exposed to the liquid injection space is a shape having a major axis and a minor axis such as a substantial elliptical shape, an elongated circle shape, a substantial oval shape, and a substantial rectangular shape.

If the cross section area of the liquid injection opening having a shape selected from any one of a substantially ellipse shape, substantially oval shape and substantially rectangular shape, is the same as the cross section area of the liquid injection opening having a circular shape, minor axes of the ellipse, oval or rectangle is shorter than the diameter of the circle, and a minimum diameter of a constriction (a constriction portion) of the ejected liquid made by the vibrations added to the liquid in the chamber is smaller than that in the case where the shape of the liquid injection opening is circular. Further, liquid has properties of becoming spherical by surface tension in space. As a result, liquid, which is ejected from the liquid injection opening having a shape selected from any one of the substantially ellipse shape, substantially oval shape and substantially rectangular shape, separates at (from) the minimum diameter portion (i.e. the constriction portion) that is smaller than in the case where the shape of the liquid injection opening is circular, and becomes spherical fine particles having a reduced diameter. Thus, the liquid is further atomized.

In other words, if the shape of the liquid injection opening is the shape having a major axis and a minor axis such as the substantially ellipse shape, and if the particle diameter of the ejected liquid is the same in size as in the case where the shape of the liquid injection opening is circular, the minor axis of the substantially ellipse shape or the like may be the same as the diameter of the circular shape. As a result, the major axis can be larger than the diameter of the circular shape, and thus the area of the liquid injection opening can be enlarged. Thus, the amount of the injected liquid (eject flow volume) can be increased.

In this event, any of the above liquid injection apparatuses is preferably configured such that the injection unit comprises an air nozzle (air current nozzle) having its one end exposed to the liquid injection space to inject not only liquid via the liquid ejection nozzle but also air (gas) via the air nozzle. With this configuration, atomized liquid droplets, which does not have the inclination to move straight in the form of fine particles, can be transported to a desired position and in a desired direction by means of the air current (this may be called “air flow”) formed by injected air (gas). It is also possible to prevent the liquid droplets from drifting at the same region to recombine (join together). That is, it is possible to prevent the particle diameter of the injected droplets from being larger by recombination of the droplets.

In any of the above liquid injection apparatuses, the one end exposed to the liquid injection space of the liquid ejection nozzle preferably provides a liquid injection opening on the undersurface of the injection unit, and the one end of the air nozzle preferably provides a gas injection opening on the undersurface of the injection unit. Thus, the liquid injection opening and the gas injection opening are formed on the same plane, so that liquid film remaining around the liquid injection opening can be removed by the air current. Accordingly, it is possible to prevent liquid droplets of a large diameter from being generated by the liquid film. Further, it is preferable that the injection unit of the liquid injection apparatus have a plurality of the liquid injection openings and a plurality of the gas injection openings, and that the liquid injection openings and the gas injection openings be arranged alternately (on the undersurface of the injection unit). With this configuration, an injection current of the liquid and an injection current of the air (gas) are next to each other, so that the liquid film can be removed more effectively, and the air current enables the liquid droplets to be transported to the desired position and in the desired direction more effectively.

For example, the liquid injection openings and the gas injection openings are arranged on lattice points of a tetragonal lattice (this maybe a rectangular lattice). In such an arrangement, it is preferable that the gas injection opening be disposed on the lattice point which is adjacent, at (with) a shortest distance, to one of the liquid injection openings (disposed on another lattice point). Also, if the liquid injection openings and the gas injection openings are arranged in each line, it is preferable that the line be arranged in a way that it becomes the line having one kind of injection port different from the other kind of injection port that an adjacent line has (i.e., in a way that the array of the liquid injection openings is disposed between the arrays of the gas injection openings).

The liquid injection apparatus having the air nozzle preferably employs injection control means for starting gas injection via the air nozzle before the start of liquid injection via the liquid ejection nozzle, and for stopping the gas injection via the air nozzle after ending of the liquid injection via the liquid ejection nozzle. With this aspect, it is possible to remove the liquid film sticking to one end (liquid injection opening) of the liquid ejection nozzle before injection and after injection, so that the liquid droplets having a large diameter are not generated at the start of injection due to the liquid film.

The liquid injection apparatus having the air nozzle is preferably configured such that the injection unit comprises an air current direction control wall for controlling the gas direction by the air nozzle. With this direction control wall, the direction of the air current can be controlled, so that the moving direction of the liquid droplets transported by the air current can be brought in a desired direction.

In this case, one end of the air nozzle (gas injection opening) is preferably disposed between one end of the liquid ejection nozzle (liquid injection opening) and the air current direction control wall (more specifically, between one end of the liquid ejection nozzle and a nodal line defined by the air current direction control wall and the undersurface of the injection unit). With this configuration, the injected liquid droplets are prevented from sticking or adhering to the air current direction control wall. It is advantageous that one end (liquid injection opening) of the liquid ejection nozzle and one end (gas injection opening) of the air nozzle are arranged alternately on the undersurface of the injection unit in order to transport the liquid droplets efficiently by the air current. Preferably, the liquid ejection nozzle and the air nozzle inject respectively liquid and gas (air) in parallel with (in a parallel direction with) each other. Thereby, the injection of the liquid can easily ride (be transported by) the air current. Further, in order to make the injected air current more stable, it is preferable to have a composition such that liquid injection velocity is lower than gas (air) injection velocity.

According to the other aspect of the present invention, there is provided a method for adjusting the resonance frequency of an injection unit in a liquid injection apparatus. The liquid injection apparatus used in the method comprises (1) an injection unit including a liquid ejection nozzle, one end of which is exposed to a liquid injection space, a chamber communicating with the other end of the liquid ejection nozzle and one end of a first liquid supply pipe, a lower electrode formed on a wall surface of the chamber, an upper electrode formed opposite to the lower electrode, and a piezoelectric/electrostrictive element formed between the lower electrode and the upper electrode, (2) drive voltage generating means for providing a drive voltage signal having a predetermined frequency across the upper electrode and the lower electrode to thereby give an electric field to the piezoelectric/electrostrictive element, to cause vibration of the wall of the chamber by actuating the piezoelectric/electrostrictive element, and (3) pressurizing means having an ejection section to which is connected the other end of the first liquid supply pipe and also having an introduction section communicating with a liquid storage tank, for pressurizing liquid (in the liquid storage tank) introduced from the introduction section to eject the liquid from the ejection section, to thereby inject the liquid into the liquid injection space via the liquid ejection nozzle of the injection unit, wherein liquid injected from the liquid ejection nozzle is atomized by the operation of the piezoelectric/electrostrictive element.

The method comprises trimming part of the upper electrode to change a region of the piezoelectric/electrostrictive element to which the electric field is applied by the upper electrode and the lower electrode, and thereby adjusting the resonance frequency of the injection unit to be substantially equal to a frequency in the vicinity of the frequency of the drive voltage signal.

According to this aspect of the present invention, it is possible to make the resonance frequency of the injection unit substantially equal to the frequency of the drive voltage signal easily by trimming the upper electrode with a laser or the like. Especially, in the apparatus including a plurality of chambers, it is possible to easily adjust the resonance frequencies between each of the chambers about the same, so that it is not necessary to comprise drive voltage generating means for generating the drive voltage signals having different frequencies for each of the chambers. Thus, it is possible to make the apparatus be less expensive.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram schematically showing a liquid injection apparatus in accordance with a first embodiment of the present invention;

FIG. 2 is a plan view of an injection unit of the liquid injection apparatus shown in FIG. 1;

FIG. 3 is a sectional view of the injection unit taken (cut on a plane) along the line 1-1 of FIG. 2;

FIG. 4 is a diagram schematically showing a liquid injection apparatus in accordance with a second embodiment of the present invention;

FIG. 5 is a diagram schematically showing a liquid injection apparatus in accordance with a third embodiment of the present invention;

FIG. 6A is a diagram showing a state where vibration energy by a piezoelectric/electrostrictive element is properly added to ejected liquid by the liquid injection apparatus in accordance with the present invention;

FIG. 6B is a diagram showing a state where the vibration energy by the piezoelectric/electrostrictive element is not sufficiently added to liquid being ejected;

FIG. 7 is a graph showing the change in the displacement (displacement change) of the piezoelectric/electrostrictive element when the frequency of a drive voltage signal added to the piezoelectric/electrostrictive element is changed;

FIG. 8A is a partially enlarged sectional view of a ceramic sheet of the injection unit and the piezoelectric/electrostrictive element in accordance with the present invention;

FIG. 8B is a plan view of the piezoelectric/electrostrictive element shown in FIG. 8A;

FIG. 8C is a partially enlarged sectional view of the ceramic sheet of the injection unit in which an upper electrode is trimmed and the piezoelectric/electrostrictive element;

FIG. 8D is a plan view of the piezoelectric/electrostrictive element shown in FIG. 8C;

FIG. 9A is a time chart showing a drive voltage signal waveform to the piezoelectric/electrostrictive element of a conventional liquid injection apparatus;

FIG. 9B is a time chart showing a drive voltage signal waveform to the piezoelectric/electrostrictive element of the liquid injection apparatus in accordance with the present invention;

FIG. 10 is a front view of an injection unit of the liquid injection apparatus in accordance with a fourth embodiment of the present invention;

FIG. 11 is a plan view of the injection unit shown in FIG. 10;

FIG. 12 is a side view of the injection unit shown in FIG. 10;

FIG. 13 is a side view of the injection unit and a suction pipe showing a state where the injection unit shown in FIG. 10 is set to the suction pipe of an internal combustion engine;

FIG. 14 is a front view of the injection unit and the suction pipe shown in FIG. 13;

FIG. 15 is a plan view of an injection unit of the liquid injection apparatus in accordance with a fifth embodiment of the present invention;

FIG. 16 is a sectional view of the injection unit taken along line 2-2 of FIG. 15;

FIG. 17 is a sectional view of a piezoelectric/electrostrictive element section shown in FIG. 15;

FIG. 18 is an enlarged sectional view of the injection unit taken along line 3-3 of FIG. 15;

FIG. 19 is a plan view of an injection unit of the liquid injection apparatus in accordance with a sixth embodiment of the present invention;

FIG. 20 is a sectional view of the injection unit taken along line 4-4 of FIG. 19;

FIG. 21 is a sectional view of the piezoelectric/electrostrictive element shown in FIG. 19;

FIG. 22 is a plan view of the injection unit of the liquid injection apparatus in accordance with a seventh embodiment of the present invention;

FIG. 23 is a sectional view of the injection unit taken along line 5-5 of FIG. 22;

FIG. 24 is a plan view of an injection unit of the liquid injection apparatus in accordance with an eighth embodiment of the present invention;

FIG. 25 is a sectional view of the injection unit taken along line 6-6 of FIG. 24;

FIG. 26 is a sectional view of the injection unit of a liquid injection apparatus in accordance with a ninth embodiment of the present invention;

FIG. 27 is a partially enlarged front view of a liquid injection opening of the injection unit and its vicinities shown in FIG. 26;

FIG. 28 is a front view of the liquid injection opening of the injection unit shown in FIG. 26;

FIG. 29 is a front view of a modification of the liquid injection opening of the injection unit shown in FIG. 26;

FIG. 30 is a front view of a modification of the liquid injection opening of the injection unit shown in FIG. 26;

FIG. 31 is a side view of an injection unit of a liquid injection apparatus in accordance with a tenth embodiment of the present invention when the injection unit is set to the suction pipe of an internal combustion engine;

FIG. 32 is a plan view of the injection unit shown in FIG. 31;

FIG. 33 is a sectional view of the injection unit taken along line 7-7 of FIG. 32;

FIG. 34 is a time chart showing driving signals of the liquid injection apparatus shown in FIG. 31;

FIG. 35 is a partially enlarged view of the vicinities of a gas injection opening of the injection unit shown in FIG. 31;

FIG. 36 is a plan view of the injection unit of a liquid injection apparatus in accordance with an eleventh embodiment of the present invention;

FIG. 37 is a sectional view of the injection unit taken along line 8-8 of FIG. 36;

FIG. 38 is a sectional view of the injection unit taken along line 9-9 of FIG. 36;

FIG. 39 is a sectional view of the injection unit taken along line 10-10 of FIG. 36; and

FIG. 40 is an enlarged partial plan view of a modification of the injection unit of the liquid injection apparatus in accordance with the present invention.

### DESCRIPTION OF THE PREFERRED EMBODIMENTS

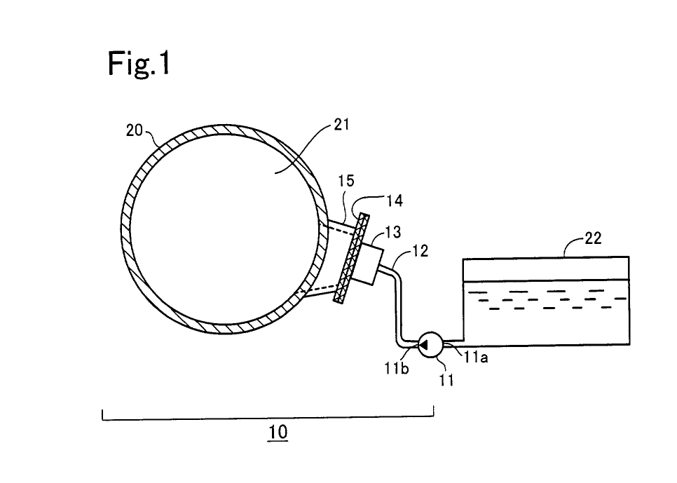

Embodiments of a liquid injection apparatus in accordance with the present invention will now be described in detail. A liquid injection apparatus (liquid spray apparatus, liquid supply apparatus, liquid eject or ejection apparatus) 10 in accordance with a first embodiment of the present invention, as shown in FIG. 1 schematically, is used to inject liquid (liquid fuel) atomized into a fuel injecting space 21 that is defined by a suction pipe 20 of an internal combustion engine or the like, for example. The liquid injection apparatus 10 comprises a pressurizing pump 11 (in this embodiment, a low-pressure pump 11) serving as pressurizing means; a first liquid supply pipe 12 serving as a first liquid supply passage; a filter 13 to which one end of the first liquid supply pipe 12 is connected for removing dust and foreign objects in the liquid; an injection unit (spray unit) 14 which communicates with one end of the first liquid supply pipe 12 via the filter 13 and comprises a plurality of chambers, each of the chambers having at least a piezoelectric/electrostrictive element formed on its outer wall surface of the chamber and a plurality of ejection nozzles to form the injected liquid into fine particles; and an eject pipe 15 for connecting the injecting unit 14 to the suction pipe 20.

The pressurizing pump 11 comprises a introduction section 11a which communicates with a bottom portion of a liquid storage tank 22 and to which liquid is supplied from the liquid storage tank 22, and an ejection section 11b connected to the other end of the first liquid supply pipe 12. This pressurizing pump 11 pressurizes the liquid introduced through the introduction section 11a from the liquid storage tank 22 up to a pressure that enables the liquid to be injected into the liquid injection space 21 via the injection unit 14 (even if the piezoelectric/electrostrictive element of the injection unit 14 is not actuated (operated)), and feeds (ejects) the liquid from the ejection section 11b to the first liquid supply pipe 12.

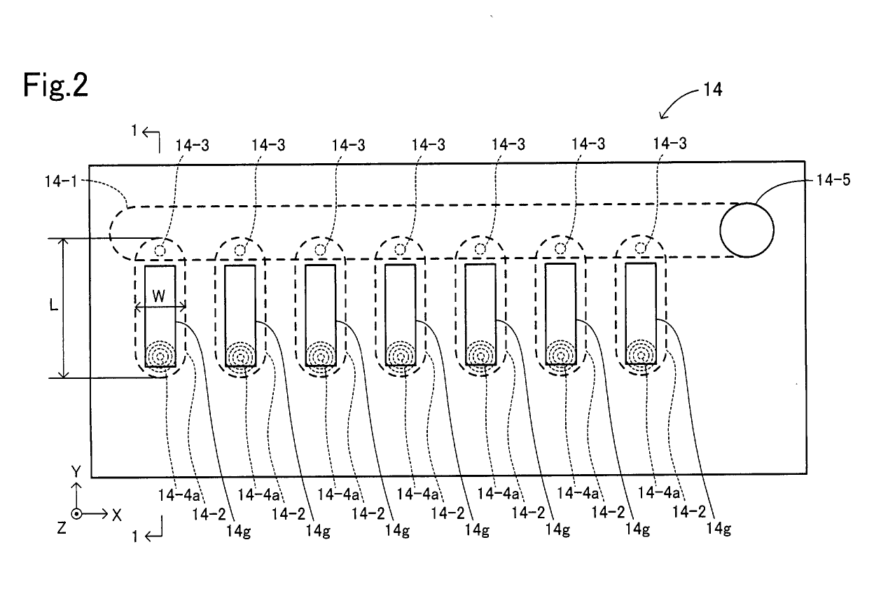

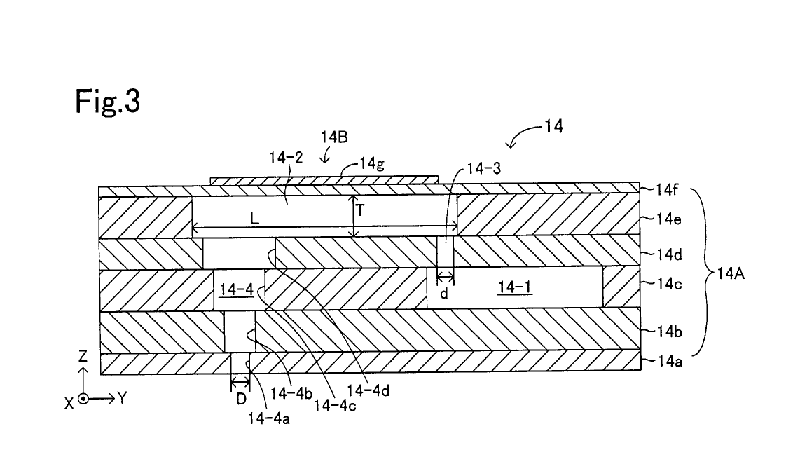

The injection unit 14, as shown in FIG. 2 being its plan view and in FIG. 3 being a sectional view of the injection unit 14 taken along line 1-1 of FIG. 2, has a substantially rectangular parallelepiped shape whose sides extend in parallel with the corresponding orthogonal X, Y, and Z axes. The injection unit 14 includes a flow passage forming section 14A comprising a plurality of ceramics thin plates (laminates, hereinafter referred to as “ceramic sheets”) 14a to 14f that are pressed (layered) and stuck by pressure, and a pressurizing section 14B comprising a piezoelectric/electrostrictive element 14g fixed onto an exterior surface (plane along an X-Y plane in Z axis positive direction) of the ceramic sheet 14f. This injection unit 14 comprises therein a liquid supply passage 14-1, a plurality (herein seven) of chambers 14-2 being mutually independent, a plurality of liquid introduction holes 14-3 having each of the chambers 14-2 communicate with the liquid supply passage 14-1, a plurality of liquid ejection nozzles 14-4 (each one end of the nozzles is substantially exposed to the liquid injection space 21 via the eject pipe 15 in a way that each of the chambers 14-2 communicates with an outer portion of the injection unit 14), and a liquid fill port 14-5 to which the filter 13 is coupled.

The liquid supply passage 14-1 is a cutout space whose shape is an elongated circle of which major and minor axes are in parallel with the X and Y axes, respectively, and which is defined by a cutout wall surface (a side wall surface) in the ceramic sheet 14c, an top (upper) surface of the ceramic sheet 14b, and an undersurface (a lower surface) of the ceramic sheet 14d. The liquid supply passage 14-1 communicates with the liquid storage tank 22 via the liquid fill port 14-5, the filter 13, the first liquid supply pipe 12, and the pressurizing pump 11. The liquid to be injected (sprayed) is supplied to the liquid supply passage 14-1 with being pressurized by the pressurizing pump 11.

Each of the plurality of chambers 14-2 is a space having a longer axis and a shorter axis (a liquid flow passage portion having a elongated longitudinal axis), the space being defined by the side wall surface of a cutout space, formed in the ceramic sheet 14e, of which shape is an elongated circle whose major and minor axes are in parallel with Y axis direction and an X axis direction, respectively, an top surface (upper surface) of the ceramic sheet 14d, and an undersurface (lower surface) of the ceramic sheet 14f. One end of each of the chambers 14-2 in the Y positive direction extends up to an upper portion of the liquid supply passage 14-1. Each of the chambers 14-2, at this one end portion, communicates with the liquid supply passage 14-1 by means of the liquid introduction hole 14-3 which is formed in the ceramic sheet 14d and has a hollow cylindrical shape having a diameter d. Hereinafter, the diameter d will also be simply referred to as “introduction hole diameter d”. The other end of each of the chambers 14-2 in the Y negative direction is connected to the other end of the liquid ejection nozzle 14-4. With this configuration, the liquid flows in the flow passage portion from the first liquid supply pipe 12 side to the liquid ejection nozzle 14-4 side.

Each of the liquid ejection nozzles 14-4 is a hollow cylindrical through-hole. The liquid ejection nozzles 14-4 is formed and comprised of one end (a liquid injection opening (port), an opening or an opening portion exposed to the liquid injection space, ejection hole) 14-4a, having a diameter D, formed in the ceramic sheet 14a, which is substantially exposed to the liquid injection space 21, and hollow cylindrical communicating holes 14-4b to 14-4d that are formed in ceramic sheets 14b to 14d whose sizes (diameters) become larger in order from the liquid injection opening 14-4a to the chamber 14-2, respectively. The axis line of each of the liquid ejection nozzles 14-4 is in parallel with Z axis. Hereinafter, the diameter D will also be simply referred to as “nozzle diameter D”.

Regarding the shape and the size of each of the chambers 14-2, in each of the chambers 14-2, at their central portion (flow passage portion), the shape of a cross section of the flow passage taken along a plane which is orthogonal to (runs at right angles to) the flowing direction of the liquid is substantially quadrangle (rectangular). A major axis L (length along Y axis) and a minor axis W (length along X axis, i.e. length of one side of the quadrangle ) of the long-shape flow passage portion have lengths of 3.5 mm and 0.35 mm, respectively, and its height T (length along Z axis, i.e. length of a side orthogonal to said one side of the quadrangle) is 0.15 mm. That is, in the quadrangle which is the shape of the section of the flow passage portion, a ratio (T/W) of a length (height T) of the first side orthogonal to the second side on which the piezoelectric/electrostrictive element is formed to a length of said second side (minor axis W) is 0.15/0.35=0.43. This ratio (T/W) is preferably of a value of 0 or more and 1 or less. Further, the diameter D of the end portion 14-4a of the liquid ejection nozzle and the diameter d of the liquid introduction hole 14-3 are 0.031 mm and 0.025 mm respectively. In this case, it is preferable that an area S1 (=W×T) of the section of the flow passage of the chamber 14-2 be larger than a cross section area S2 (=π·(D/2)²) of the end portion 14-4a of the liquid ejection nozzle, and be larger than a cross section area S3 (=π·(d/2)²) of the liquid introduction hole 14-3. Also, to form the liquid into fine (minute) particles, the cross section area S2 is preferably larger than the cross section area S3.

Each of the piezoelectric/electrostrictive elements 14g is slightly smaller than each of the chambers 14-2 in a planar view (as viewed from a point on the Z axis positive direction), and is fixed (joined by burning) onto the top surface of the ceramic sheet 14f (i.e. the surface of the wall including one side of the quadrangle which is the section of the flow passage portion of the chamber 14-2) in such a manner as to be disposed within the chamber 14-2 in the planar view. Each of the piezoelectric/electrostrictive elements 14g operates (is driven) on the basis of the potential difference given by an electric control device (driving device, i.e., drive voltage signal generating means), not shown, between electrodes (not shown) disposed on an top surface and an undersurface of each of the piezoelectric/electrostrictive elements 14g, to deform the ceramic sheets 14f (upper wall of the chamber 14-2) for changing a capacity of the chamber 14-2 by ΔV.

As to a method of forming the ceramic sheets 14a-14f and layers of them, the following method is adopted:

1; Ceramic green sheets are formed using zirconia powder whose particle diameter is 0.1 to several μm.

2; Punching processing using a mold tool and a die is applied to the ceramic green sheets, so as to form cutout portions (notches, spaces that correspond to the chamber 14-2, the liquid introduction hole 14-3, the liquid supply passage 14-1, the liquid ejection nozzle 14-4 and the liquid fill port 14-5 (see FIG. 2)) that are included in the ceramic sheets 14a-14e shown in FIG. 3, respectively.

3; Each of the ceramic green sheets are layered, heated and stuck by pressure, and then burnt at 1450° C. for 2 hours to be integrated.

The piezoelectric/electrostrictive elements 14g sandwiched between electrodes are formed on an top surface that corresponds to a chamber part of the layer of the ceramic sheets which is formed according to above processes, to obtain the injection unit 14.

The liquid injection apparatus 10 having configurations as above is applied to the internal combustion engine for injecting (spraying) gasoline into the suction pipe (the intake pipe) 20 to operate the internal combustion engine. That is, the gasoline pressurized by the pressurizing pump 11 is supplied to the injection unit 14 via the first liquid supply pipe 12 and the filter 13. Vibrations (vibration energy) caused by vibrating the piezoelectric/electrostrictive elements 14g at a predetermined period (i.e. with a predetermined driving frequency) are given to the gasoline flowing in the chamber 14-2 in the injection unit 14. The gasoline is injected from the liquid injection opening 14-4a of the liquid ejection nozzle 14-4 with being atomized (being formed into minute droplets)by the vibrations.

In the above application, the strength of the vibrations given to the liquid changes depending upon the potential difference applied across the electrodes (not shown) disposed on the top surface and the undersurface of the piezoelectric/electrostrictive elements 14g (i.e., strength of an electric field added to the piezoelectric/electrostrictive elements 14g), and the thickness of the ceramic sheet 14f (upper wall of the chamber 14-2), and so on. In this example, the ceramic sheet 14f is deformed by the operation of the piezoelectric/electrostrictive elements 14g. When the capacity variation ΔV of the chamber 14-2 thus obtained is expressed by using a ratio of the capacity V of the chamber 14-2 to the variation ΔV (V/ΔV, i.e., chamber capacity/capacity variation), the ratio V/ΔV is 1500. It is noted that preferably, this ratio V/ΔV is two or more and 3000 or less, more preferably two or more and 1500 or less.

The liquid droplets of the gasoline injected under such conditions described above are similarly sized (i.e. their sizes are uniform). The diameter of the droplets is 30 μm. Therefore, fuel consumption is improved and an amount of undesirable exhaust gas is reduced.

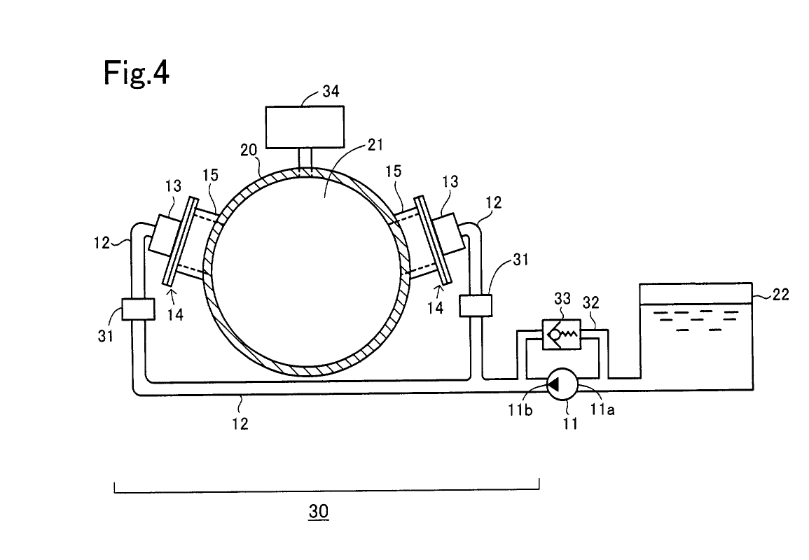

A liquid injection apparatus 30 in accordance with a second embodiment of the present invention will then be described with reference to FIG. 4 that schematically shows the apparatus 30. This liquid injection apparatus 30 is different from the liquid injection apparatus 10 according to the first embodiment in that a pair of injection units 14 are connected to the suction pipe 20 on the right and left sides via each of the eject pipes 15, and that the injection apparatus 30 comprises a pair of electromagnetic open-close valves 31, a bypass pipe 32 having a check valve 33 therein, and a pressure sensor 34.

The configuration (arrangement) of each injection unit 14 is the same as that of the first embodiment (shown in FIG. 1). Each of the first liquid supply pipes 12 is connected to each injection unit 14 that comprises a plurality of chambers, each chamber having at least a piezoelectric/electrostrictive element formed on its wall surface of each of the chambers and a plurality of liquid ejection nozzles, to form the injected liquid into fine particles, via each filter 13 for removing dust and foreign objects in the liquid. There is a single liquid storage tank 22 and a single pressurizing pump 11 for pressurizing liquid that are commonly used for a pair of the injection units 14.

The electromagnetic open-close valve 31 is interposed in each of the first liquid supply pipe (first liquid supply passage) 12, and opens and closes each passage of the first liquid supply pipe 12 in response to an instruction signal from the electric control device (not shown). The bypass pipe 32 makes the liquid storage tank 22 communicate with the first liquid supply pipe 12 at between each of the electromagnetic open-close valves 31 of the first liquid supply pipe 12 and the ejection section 11b of the pressurizing pump 11, in parallel with the pressurizing pump 11. The bypass pipe 32 has the check valve (relief valve) 33 interposed therein. Only when the pressure of the liquid in the first liquid supply pipe 12 at between the electromagnetic open-close valves 31 and the ejection section 11b of the pressurizing pump 11 is beyond a predetermined pressure, the check valve 33 allows the liquid to flow from the first liquid supply pipe 12 at between the electromagnetic open-close valves 31 and the ejection section 11b of the pressurizing pump 11 to the liquid storage tank 22. The pressure sensor 34 detects the pressure inside the suction pipe 20, and sends the signal indicative of the detected pressure to the electric control device not shown.

The liquid injection apparatus 30 configured as above is applied to the internal combustion engine for injecting (spraying) gasoline into the suction pipe (the intake pipe) 20 to operate the internal combustion engine. That is, the gasoline pressurized by the pressurizing pump 11 is supplied to each of the injection units 14 via each of the first liquid supply pipes 12, each of the electromagnetic open-close valves 31, and each of the filters 13. Vibrations (vibration energy) caused by vibrating the piezoelectric/electrostrictive elements 14g at a predetermined period are given to the gasoline flowing in the chambers 14-2 in the injection units 14. With the vibrations, the gasoline is atomized (the gasoline is formed into minute droplets) and is injected from the liquid injection opening 14-4a of the liquid ejection nozzle 14-4.

The liquid injection apparatus 30 can inject a greater amount of gasoline in parallel, compared with the aforementioned liquid injection apparatus 10, by using two injection units 14, and can perform substantial ON/OFF operation of the injection (injection, and stop injecting) with using the electromagnetic open-close valves 31, thereby accomplishing more delicate control of the injection amount and injection timing. As a result, fuel consumption is improved more greatly and an amount of the undesirable exhaust gas is greatly decreased because of the above advantageous in precise control for the injection amount and injection timing together with the spray of fine (minute) droplets of the liquid according to the liquid injection apparatus 30 (i.e., the injection unit 14), similarly to the liquid injection apparatus 10.

In addition, the output of the pressurizing pump 11 (a discharge amount from the pump 11) can be adjusted in accordance with the signal generated by the pressure sensor 34 which detects the pressure in the suction pipe 20; that is, when the pressure in the suction pipe 20 is higher than a predetermined value, the output of the pressurizing pump 11 can be increased to heighten the pressure of the liquid ejected from the ejection section 11b, and when the pressure in the suction pipe 20 is low (is lower than the predetermined value), the output of the pressurizing pump 11 can be decreased to reduce the pressure of the liquid. With this configuration, it becomes possible to inject liquid droplets uniformly atomized regardless of the surrounding environment, and to improve the accuracy of the injection amount, according to the liquid injection apparatus 30. Further, since the liquid injection apparatus 30 includes the bypass pipe 32 (bypass) in which the check valve 33 is interposed (disposed) in parallel with the pressurizing pump 11, the liquid in the liquid supply pipe 12 can be returned to the liquid storage tank 22 when the pressurizing pump 11 is driven while the electromagnetic open-close valve 31 closes the passage of the first liquid supply pipe 12, and when the pressure inside the liquid supply pipe 12 rises beyond the predetermined pressure. Therefore, it is possible to avoid breakage of the liquid injection apparatus 30, unnecessary liquid leakage and the like.

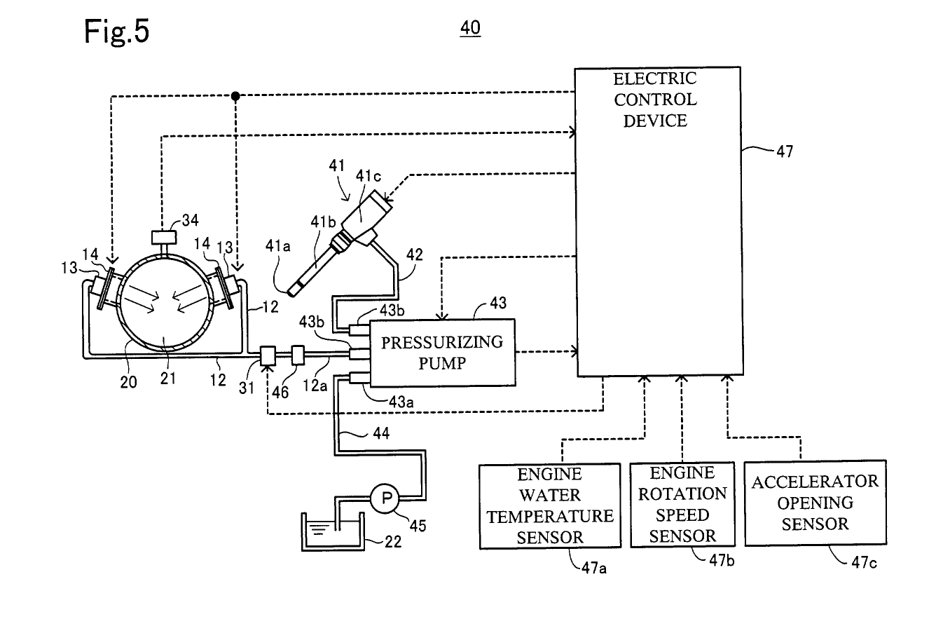

A liquid injection apparatus 40 in accordance with a third embodiment of the present invention will then be described with reference to FIG. 5 that schematically shows the apparatus 40. This liquid injection apparatus 40 is different from the liquid injection apparatus 30 according to the second embodiment in that the apparatus 40 further comprises an injection valve (injector) 41, a second liquid supply pipe (second liquid supply passage) 42, a pressurizing pump 43 serving as pressurizing means being a high-pressure pump instead of the pressurizing pump 11, a third liquid supply pipe 44, a fuel pump (liquid supplying pump) 45, and a regulator 46.

The configuration (arrangement) of each of the injection units 14 is similar to that of the liquid injection apparatus 30 of the second embodiment shown in FIG. 4, and a pair of injection units 14 is set to the suction pipe 20 both on the right and left sides via each of the eject pipes 15. Each of the first liquid supply pipes 12 is coupled to each of the injection units 14 that comprises a plurality of chambers, each chamber having at least a piezoelectric/electrostrictive element formed on its wall surface of each of the chambers and a plurality of liquid ejection nozzles, to form the injected liquid into fine particles, via each filter 13 for removing dust and foreign objects in the liquid. The liquid injection apparatus 40 comprises only one electromagnetic open-close valve 31. This electromagnetic open-close valve 31 is interposed in the first liquid supply pipe 12 at a position before the pipe 12 branches towards each of the injection units 14 (i.e., confluent portion of the first liquid supply pipe 12).

The injection valve 41 comprises a liquid injection opening 41a exposed to a proper place in the liquid injection space 21 formed by the suction pipe 20, a liquid passage 41b communicating with the liquid injection opening 41a, and an electromagnetic valve 41c for opening and closing the liquid passage 41b. The liquid passage 41b communicates with an ejection section 43b of a pressurizing pump 43 via a second liquid supply pipe 42. That is, in the third embodiment, the ejection section 43b of the pressurizing pump 43 is connected to the injection valve 41, comprising the electromagnetic valve 41c and the liquid injection opening 41a, via the second liquid supply pipe 42 which forms a course different from a course which is formed via the first liquid supply pipe 12. As described above, the liquid injection apparatus 40 includes additionally a structure in which what is called an electrically controlled fuel injection apparatus.

A third liquid supply pipe (third liquid supply passage) 44 has the fuel pump 45 interposed therein. One end of the third liquid supply pipe 44 is connected to the liquid storage tank 22, and its the other end is connected to an introduction section 43a of the pressurizing pump 43. The fuel pump 45 supplies the liquid from the liquid storage tank 22 to the pressurizing pump 43. The fuel pump 45 is a low-pressure (type) pump. Thus, the pressure by the fuel pump 45 can not have the fuel sprayed into the suction pipe 20. Therefore, the pressurizing pump 43 pressurizes the fuel to a pressure which enables the fuel to be sprayed into the suction pipe 20. In the present embodiment, since the liquid storage tank 22 is disposed away from the injection unit 14 just like ordinary vehicles, the fuel from the liquid storage tank 22 is supplied to the pressurizing pump 43 disposed in the vicinity of the injection unit 14 by the fuel pump 45. Adopting such arrangement and configuration, it is possible to avoid the pressure reduction of the liquid ejected from the pressurizing pump 43, and to inject the liquid efficiently and accurately.

The regulator 46 is interposed between the electromagnetic open-close valve 31, which is interposed in the first liquid supply pipe 12, and the ejection section 43b of the pressurizing pump 43, for reducing the pressure of the liquid ejected from the pressurizing pump 43 to supply the depressurized liquid to each injection unit 14 via the electromagnetic open-close valve 31 or the like. Since the pressure generated by the pressurizing pump 43 is the pressure given to the conventional injection valve 41 (what is called the electrically controlled fuel injection apparatus) via the second liquid supply pipe 42 of the different system (course), the pressure must be a high pressure of several atmospheres or more to form the fuel to be injected from the injection valve 41 into fine particles. Therefore, the fuel whose pressure is adjusted (reduced) by the regulator 46 is supplied to the injection unit 14 (of the other fuel injection system). In this way, the two systems share the expensive pump that leads to increase costs of the apparatus, to reduce the cost of the apparatus.

An electric control device 47 includes an microcomputer (not shown) as a main component, and is connected to an engine coolant temperature sensor 47a for detecting the temperature of engine cooling water, an engine rotation speed sensor 47b for detecting the rotation speed of the engine, an accelerator opening sensor 47c for detecting the accelerator opening, the aforementioned pressure sensor 34, and the pressurizing pump 43. The electric control device 47 inputs signals from these sensors and the like. The electric control device 47 is also connected to each of the injection units 14 (each of the piezoelectric/electrostrictive elements 14g of the injection units 14), the electromagnetic open-close valve 31, the injection valve 41 (the electromagnetic valve 41c), and the pressurizing pump 43 to output driving signals necessary for these.

The liquid injection apparatus 40 configured as above is applied to the internal combustion engine for injecting (spraying) gasoline into the suction pipe (the intake pipe) 20 to operate the internal combustion engine. That is, the apparatus 40 injects the gasoline by generating driving signals for the injection units 14, the electromagnetic open-close valve 31, the injection valve 41 (what is called the electrically controlled fuel injection apparatus), and the pressurizing pump 43, from the electric control device 47 with monitoring the operating conditions of the internal combustion engine by using the various sensors 34, 47a to 47c and with referring to the signal from the pressurizing pump 43. The electromagnetic open-close valve 31, the two injection units 14, and the injection valve 41 can be selectively driven independently or together based on the required injection amount and the required particle diameter of the gasoline to be injected. Thereby, it becomes possible to accomplish more improvement of fuel consumption and a reduction of undesirable exhaust gas in a wide range from the start of operation of the internal combustion engine to the stationary state.

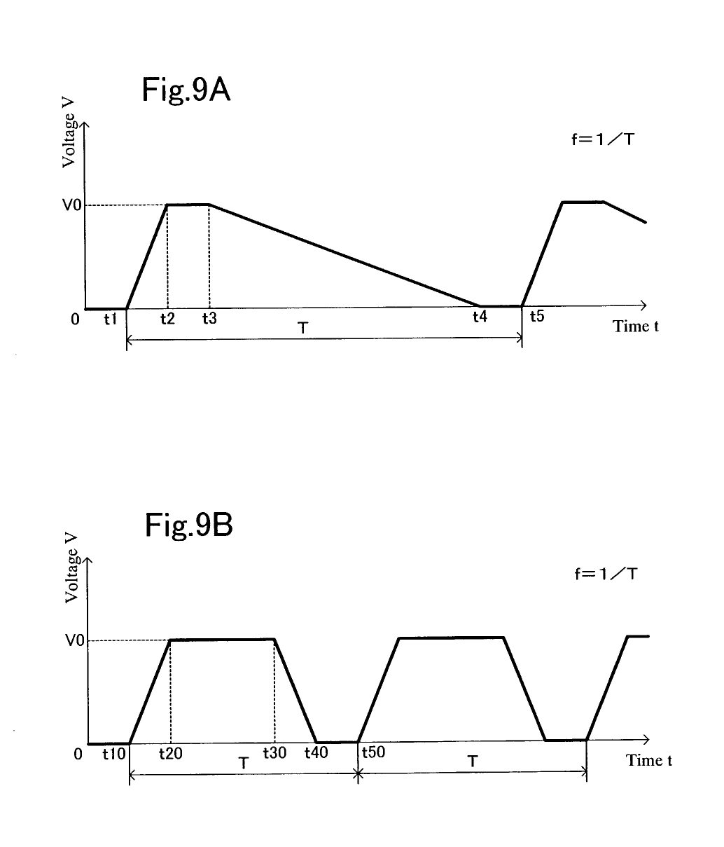

In the liquid injection apparatuses according to the first to third embodiments, an experiment was conducted to find the relationship among the nozzle diameter D, the introduction hole diameter d of the injection unit 14, and the eject state of liquid droplets. In this experiment, the injection unit 14 was used, in which a length L of the major axis of the chamber 14-2 is 3.5 mm, a length W of one side of the section of the chamber 14-2 and a height T of another side of the section of the chamber 14-2 are 0.35 mm and 0.15 mm respectively, and gasoline is used as the ejected liquid. At the time of injection (the time of eject), the liquid pressure in the chamber 14-2 was raised up to 0.1 MPa by the pressurizing pumps 11 and 43, and the drive voltage signal shown in FIG. 9B was given to the piezoelectric/electrostrictive elements 14g. A driving frequency f and a maximum voltage V0 of the drive voltage signal were 45 kHz and 20 V respectively. The results of the experiment are shown in Table 1. It is noted that, in this experiment, the state of injection (ejection) is regarded as good (indicated with a mark “◯” in Table 1) when the size of the liquid droplets at a position 5 mm away from an end portion of the liquid injection opening 14-4a toward the side of the injection space is smaller than the nozzle diameter D, and the liquid droplets are ejected stably. The state of injection is regarded as poor (indicated with a mark “X” in Table 1) otherwise.

TABLE 1

| | | Introduction | Nozzle | |
|---|---|---|---|---|
| | Nozzle | hole | diameter/Introduction | |
| Sample | diameter | diameter | hole diameter | Eject |
| name | D (mm) | d (mm) | (D/d) | state |
| Sample 1 | 0.031 | 0.005 | 6.200 | x |
| | | | | (unstable) |
| Sample 2 | 0.031 | 0.007 | 4.429 | ∘ |
| Sample 3 | 0.031 | 0.025 | 1.240 | ∘ |
| Sample 4 | 0.025 | 0.031 | 0.806 | x |
| | | | | (unstable) |
| Sample 5 | 0.031 | 0.031 | 1.000 | x |
| Sample 6 | 0.050 | 0.007 | 7.143 | x |
| Sample 7 | 0.050 | 0.025 | 2.000 | ∘ |

As understood from Table 1, if the ratio (D/d) of the nozzle diameter D to the introduction hole diameter d is larger than 6.200, stable eject is not performed (see Sample 1). It is inferred that, if the introduction hole diameter d is too small with respect to the nozzle diameter D, flow passage resistance in the liquid introduction hole 14-3 becomes excessively large, and therefore the amount of the liquid flowing into the chamber 14-2 becomes insufficient. Accordingly, it is preferable that the ratio D/d be smaller than 6.200 (more preferably, 5.000 or less, and further preferably 4.429 or less (see Sample 2).

Furthermore, as understood from Table 1, if the ratio D/d is smaller than 1.000, stable eject is not performed (see Sample 5). It is inferred that, because the introduction hole diameter d is too large with respect to the nozzle diameter D, vibrations (vibration energy) of the piezoelectric/electrostrictive elements 14g added to the liquid are absorbed in the liquid supply passage 14-1 via the liquid introduction hole 14-3, the vibrations (vibration energy) are not adequately added to the liquid injected from the chamber 14-2 via the ejection nozzle 14-4.

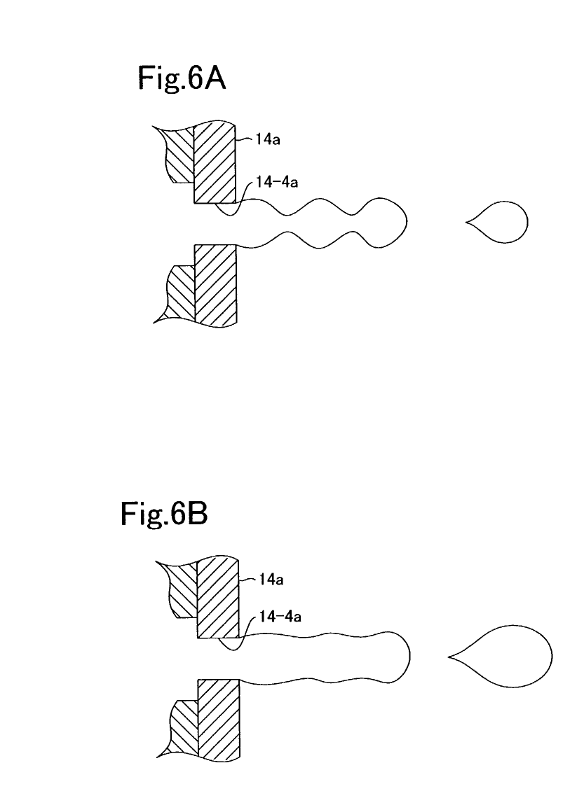

FIG. 6A is a diagram showing a state where vibration energy of the piezoelectric/electrostrictive element 14g is properly (adequately) added to ejected liquid by the liquid injection apparatus in accordance with the present invention. In this way (as understood from FIG. 6A), when the vibration energy by the piezoelectric/electrostrictive element 14g is properly added to ejected liquid, a constriction is generated in the liquid pressed out (ejected liquid) toward the liquid droplet injection space by the pressure of the pressurizing pumps 11, 43 from an end surface of the liquid injection opening 14-4a, and the (leading) end portion of the liquid breaks away from the constriction portion as if it is torn off, and therefore the ejected liquid is atomized.

On the other hand, FIG. 6B shows a state where the vibration energy by the piezoelectric/electrostrictive element 14g is not sufficiently added to the liquid being ejected because the introduction hole diameter d is too large with respect to the nozzle diameter D. In this way, when the vibration energy by the piezoelectric/electrostrictive element 14g is not properly added to the liquid, the constriction is not made in the liquid being ejected, and the end portion of the liquid breaks away having size dependent only on its surface tension, so that the liquid in not atomized.

As understood from the above description, in order to transmit (add) the vibrations of the piezoelectric/electrostrictive element 14g sufficiently to ejected liquid, it is preferable that the ratio D/d be larger than 1.000 (more preferably 1.240 or more). That is, it is preferably that the cross section area (cross section area of the liquid injection opening 14-4a) of one end of the liquid ejection nozzle 14-4 exposed to the liquid injection space, the area being determined by the nozzle diameter D, be larger than the cross section area of the liquid introduction hole 14-3, the area being determined by the introduction hole diameter d.

Furthermore, similar experiments were conducted in which the nozzle diameter D was varied. From the experiments, it turned out that it is preferable that the nozzle diameter D be desirably 0.1 mm or less, more preferably 0.02 to 0.04 mm. This is because, if the nozzle diameter D is larger than 0.1 mm, it is difficult to atomize the injected liquid droplets, and if the nozzle diameter D is smaller than 0.02 mm, dust contained in the liquid (such as fuel) easily clogs the liquid injection opening 14-4a, so that the practicability of the apparatus deteriorates.

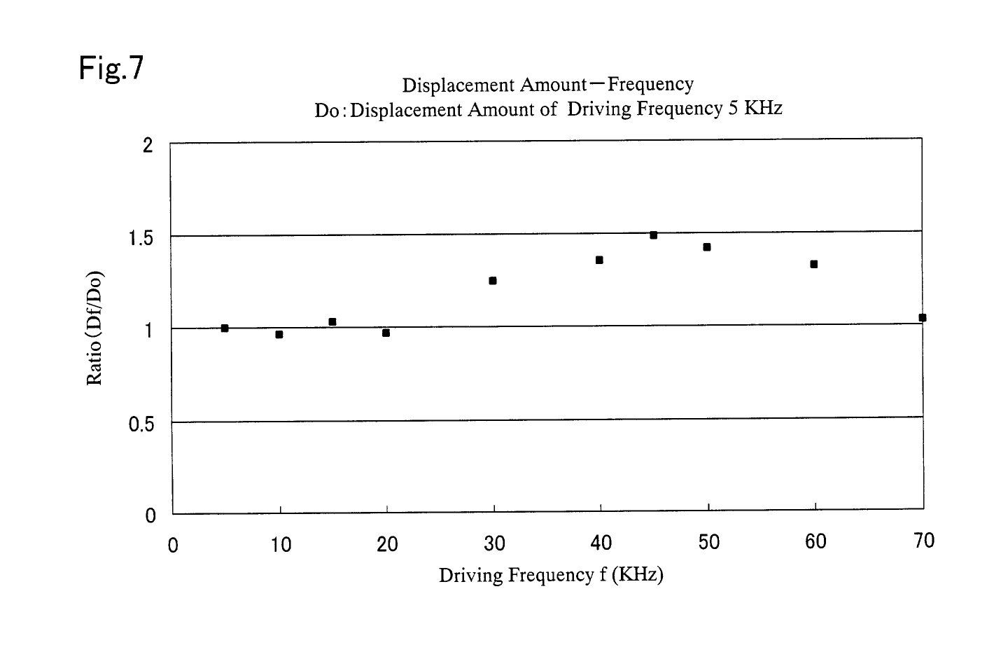

Another experiments were conducted for the liquid injection apparatuses according to the first to third embodiments in order to study maximum displacement amount of the piezoelectric/electrostrictive element 14g (i.e. maximum value of displacement of the piezoelectric/electrostrictive element 14g in the Z axis direction in FIG. 3). In the experiments, potential difference in the form of sine wave (drive voltage signal of driving frequency f=1/T, period T) was given across the electrodes of the piezoelectric/electrostrictive element 14g. The results of the experiments are shown in FIG. 7. A vertical axis of FIG. 7 indicates the ratio (D_{f}/D₀) of the maximum displacement amount D_{f} of the piezoelectric/electrostrictive element 14g in each driving frequency f, to the maximum displacement amount D₀ of the piezoelectric/electrostrictive element 14g in the case where the driving frequency f is 5 kHz.

As shown in FIG. 7, the ratio (D_{f}/D₀) becomes maximum when the driving frequency f is in the vicinity of 50 kHz. The frequency in the vicinity of 50 kHz is substantially equal to the resonance frequency (inherent vibration frequency) of the injection unit. The resonance frequency of the injection unit can be determined by the structure of the chamber 14-2, the structure of the liquid ejection nozzle 14-4, the nozzle diameter D, the introduction hole diameter d, the shape of the portion that deforms the ceramic sheet 14f of the piezoelectric/electrostrictive element 14g, and the kind of liquid to be injected. More specifically, it turned out that the pressure of the liquid can be vibrated with less energy by providing the drive voltage signal having the driving frequency f in the vicinity of the resonance frequency of the injection unit 14 since it is possible to let the piezoelectric/electrostrictive element 14g make strong vibrations even if the amplitude of the drive voltage signal is kept unchanged. Thus, it is evident that, in the liquid injection apparatus in accordance with the present invention, the driving frequency f of the piezoelectric/electrostrictive element 14g is preferably set at the frequency in the vicinity of the resonance frequency of the injection unit 14 (i.e. frequency 0.7 to 1.3 times as high as the resonance frequency, i.e., within ±30% of the resonance frequency).

Next, a method for setting (adjusting) the driving frequency f of the injection unit 14 at the frequency in the vicinity of the resonance frequency will be described. Generally, in such a liquid injection apparatus, it is not easy to adjust the driving frequency f of the drive voltage signal generated by the drive voltage generating circuit after the apparatus is manufactured (completed), because a drive voltage generating circuit (drive voltage generating means, applied voltage generating means or a driving source) for the piezoelectric/electrostrictive element 14g is built in the electric control device. Therefore, in each embodiment of the present invention, the resonance frequency is changed by trimming the upper electrode of the piezoelectric/electrostrictive element 14g, to make the resonance frequency substantially equal to the driving frequency f.

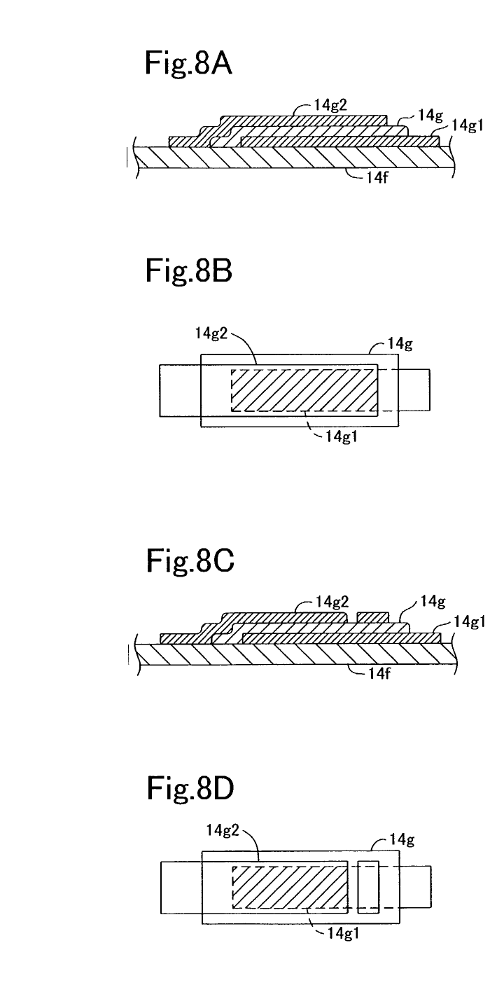

Hereinafter, an adjusting method of (a method for adjusting) the resonance frequency by the trimming will be more concretely described. FIG. 8A is a partially enlarged sectional view of the ceramic sheet 14f of the injection unit 14, and the piezoelectric/electrostrictive element 14g. FIG. 8B is a plan view of the piezoelectric/electrostrictive element 14g. As shown in these drawings, a lower electrode 14g1 is formed on the ceramic sheet 14f extending from right to left in FIGS. 8A, 8B, to be a thin plate (layer) having a shape of substantially rectangular in a plan view. The piezoelectric/electrostrictive element 14g is a thin plate (layer) of which shape is a substantially rectangular in a plan view, its outer circumferential portion is formed on the ceramic sheet 14f, and its central portion is formed on the lower electrode 14g1. An upper electrode 14g2 is thin plate (layer) having a shape of substantially rectangular in a plan view, and is formed on both the ceramic sheet 14f and the piezoelectric/electrostrictive element 14g. The upper electrode 14g2 extends from left to right in FIGS. 8A, 8B, and is formed opposite to the lower electrode 14g1. As a result, the piezoelectric/electrostrictive element 14g is interposed between the upper electrode 14g2 and the lower electrode 14g1 in a region (a region with hatching in FIG. 8B) where the upper electrode 14g2 and the lower electrode 14g1 are overlapped in a plan view. An electric field by the drive voltage signal is added to this region, and therefore, this region generates force to deform the ceramic sheet 14f.

As shown in FIG. 8C, similar to FIG. 8A, which is a sectional view of the piezoelectric/electrostrictive element 14g and the like, and FIG. 8D similar to FIG. 8B, which is a plan view of the piezoelectric/electrostrictive element 14g and the like, part of the upper electrode 14g2 is cut off (removed, or trimmed) by a laser in the minor axis direction (i.e. in the direction straight orthogonal to the longitudinal direction) in order to adjust the resonance frequency. In this way, as shown with the region with hatching in FIG. 8D, the area of the region where the upper electrode 14g2 and the lower electrode 14g1 are overlapped (i.e., area of the region that generates the force to deform the ceramic sheet 14f by the drive voltage signal) becomes smaller than in the case of FIG. 8B, thus the resonance frequency changes.

In the present embodiment, the resonance frequency is made equal to the driving frequency f by trimming the upper electrode 14g2 as described above.

Therefore, according to the method above, if the injection unit 14 comprises a plurality of portions each of which includes the piezoelectric/electrostrictive element 14g and the chamber 14-2 and the like as shown in FIG. 3, it is possible to have the resonance frequency of each of the portions substantially equal to the driving frequency f of the single drive voltage generating circuit, by trimming the each of the upper electrodes 14g2 of the piezoelectric/electrostrictive elements 14g. Thus, according to the present embodiment, it is possible to efficiently atomize the injected fuel with a little energy, without comprising a plurality of drive voltage generating circuits having different driving frequencies.

Consideration will then be made on waveforms of the drive voltage signal applied to the piezoelectric/electrostrictive element 14g. FIG. 9A shows a typical waveform of the drive voltage signal given to the piezoelectric/electrostrictive element in a liquid droplet ejection device that does not comprise the pressurizing pumps 11, 43 similar to conventional ink jet devices. This drive voltage is increased to voltage V0 at a predetermined voltage change rate from the timing t1 to the timing t2, to pressurize the liquid in the chamber for ejecting the liquid from the liquid injection opening. The voltage is maintained at V0 from the timing t2 to the timing t3, and the voltage is gradually decreased at the predetermined voltage change rate from the timing t3 to the timing t4 to reduce the pressure in the chamber, thereby introducing the liquid into the chamber from the liquid supply passage via the liquid introduction hole.

The reason why the absolute value of the voltage change rate (V0/(t4−t3)) when reducing the pressure (when introducing liquid) is made smaller than the absolute value of the voltage change rate (V0/(t2−t1)) when increasing the pressure (when ejecting) is to introduce the liquid sufficiently into the chamber in the apparatus that does not include the pressurizing pumps 11 and 43. In other words, since flow passage resistance in the liquid introduction hole becomes relatively large if the depressurizing rate (rate of decreasing the pressure) is too high, the liquid is not sufficiently introduced from the liquid supply passage into the chamber, and air bubbles might be generated. Therefore, in the conventional liquid injection apparatus, it is necessary to reduce the depressurizing rate by using the drive voltage signal as shown in FIG. 9A in order to prevent the air bubbles from being generated. However, this makes the period T of the drive voltage signal longer, and thus it is difficult to sufficiently increase the eject (injection) amount per unit time.

On the contrary, since the liquid injection apparatus in accordance with the present invention comprises the pressurizing pump 11 or 43, a large amount of the flow in the liquid introduction hole 14-3 is ensured without generating the air bubbles even if the depressurizing rate is relatively high. Therefore, as shown from the timing t30 to the timing t40 in FIG. 9B, the voltage of the drive voltage signal is reduced at the voltage change rate (V0/(t40−t30)) that makes it possible to obtain a higher depressurizing rate than the conventional depressurizing rate. This enables the period T of the drive voltage signal to be short, and the eject (injection) amount per unit time to be increased.

On the other hand, in the liquid injection apparatus in accordance with the present invention, if the voltage of the drive voltage signal starts decreasing (i.e. starts reducing the pressure of the liquid in the chamber) immediately after finishing pressurizing (immediately after the timing t20), the air bubbles might be generated inside the liquid introduction hole 14-3 and in its vicinities. This is because, the pressure of the liquid inside the liquid introduction hole 14-3 and in its vicinities is significantly increased due to both the pressure increase caused by the pressurization of the pressurizing pumps 11, 43 and the pressure increase caused by the pressurization of the piezoelectric/electrostrictive element 14g, and therefore, the pressure change will be excessively large if the depressurization is started immediately after the liquid pressure there is increased to that large.

From above mentioned viewpoint, in the liquid injection apparatus in accordance with the present invention, the voltage of the drive voltage signal is increased between the timing t10 and the timing t20 to pressurize the liquid in the chamber 14-2, however, the voltage of the drive voltage signal is kept at the constant voltage V0 until the timing t30 when the pressure inside the liquid introduction hole 14-3 and in its vicinities returns to the pressure pressurized only by the pressurizing pumps 11 and 43, instead of starting to decrease the voltage of the drive voltage signal to compulsively reduce the pressure by the drive voltage signal at (from) the timing t20. This enables not only to prevent the air bubbles from being generated inside the liquid introduction hole 14-3 and in its vicinities, but also to have a considerable liquid injection amount per unit time.

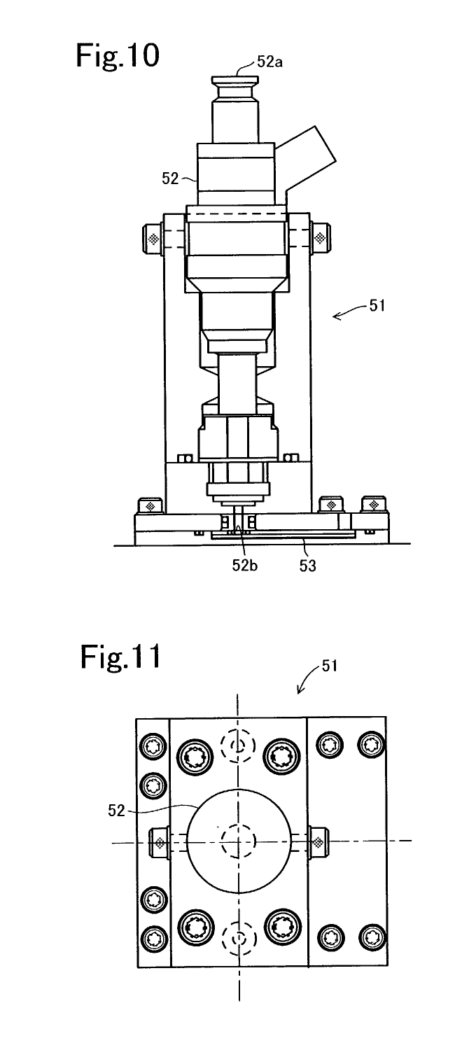

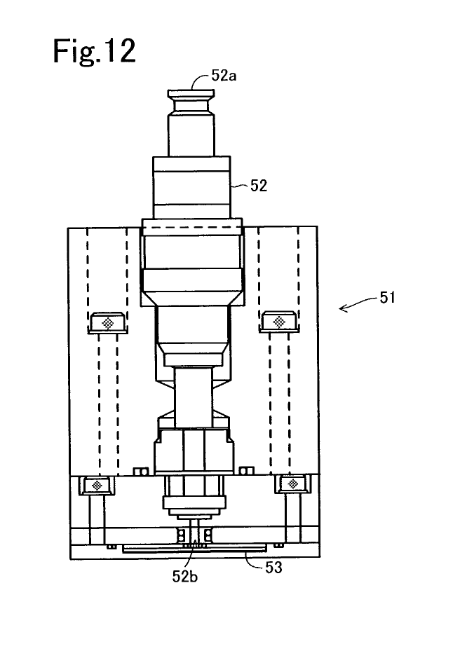

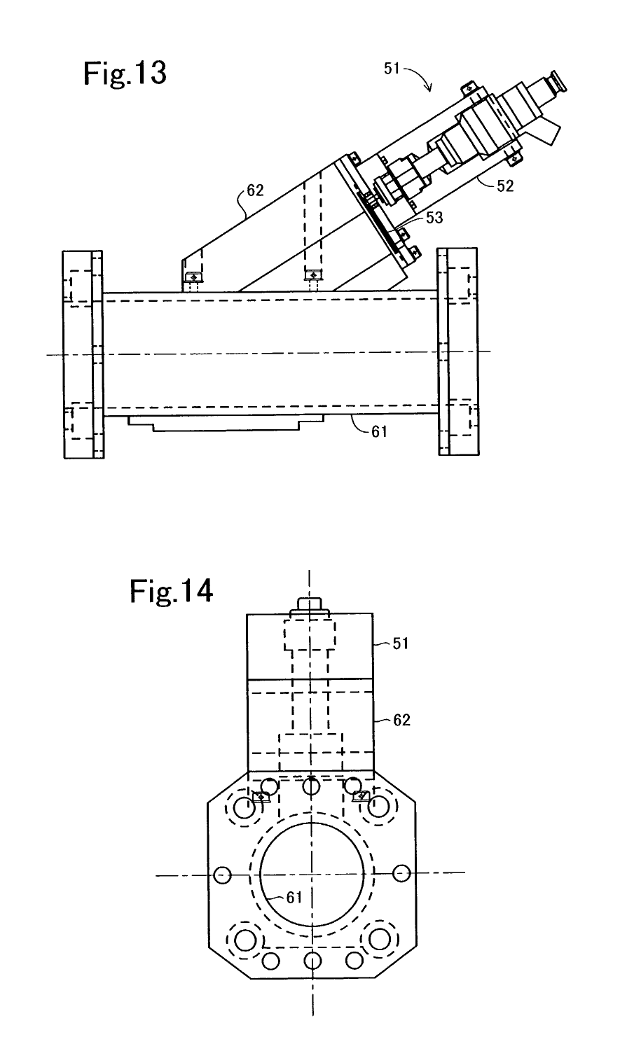

A liquid injection apparatus in accordance with a fourth embodiment of the present invention will then be described with reference to FIG. 10 to FIG. 14. An injection unit 51 of this liquid injection apparatus is shown in a front view of FIG. 10, a plan view of FIG. 11, and a side view of FIG. 12. The injection unit 51, as shown in a side view of FIG. 13 and a front view of FIG. 14, is fixed via an eject pipe 62 to a suction pipe 61 which forms an intake passage of the internal combustion engine and the liquid injection space. The injection unit 51 comprises a fuel injector 52 for injecting fuel and an injection unit 53 for forming liquid into fine particles using the piezoelectric/electrostrictive element.

The fuel injector 52 for injecting fuel is a well known injector conventionally in wide use in the electrically controlled fuel injection apparatus, and herein functions as the electromagnetic open-close valve (electromagnetic open-close eject valve). The fuel injector 52 comprises a liquid introduction hole 52a, an liquid passage (not shown), an electromagnetic open-close needle valve (electromagnetic valve) for opening and closing the liquid passage, and a liquid eject port 52b. Similarly to the liquid injection apparatuses in the first to third embodiments, the liquid introduction hole 52a is supplied with the fuel from the liquid storage tank (not shown) by the pressurizing pump(not shown). This injector 52 ejects the liquid from the liquid eject port 52b when the electromagnetic open-close needle valve is opened by a valve open drive signal from the electric control device. The pressure of the fuel supplied to the liquid introduction hole 52a is kept at a constant value by an pressure regulator (not shown).

The injection unit 53 for forming liquid into fine particles has the same configuration (arrangement, or composition) as those described with reference to FIG. 2 and FIG. 3. A plane on which the liquid injection openings 14-4a shown in FIG. 2 and FIG. 3 is formed is positioned to be orthogonal to the axial direction of the injector 52. The liquid fill port 14-5 shown in FIG. 2 is connected to the liquid eject port 52b of the fuel injector 52. As mentioned above, this injection unit 51 is fixed to the suction pipe 61 in a manner that the main axis direction of the injection from the injection unit 53 via the eject pipe 62 crosses a line extending in a direction parallel to the axial line of the suction pipe 61 with an acute angle, and the injection unit 51 injects the atomized fuel (the fuel formed into fine particles) into the suction pipe 61.

As described above, the liquid injection apparatus according to the fourth embodiment has the configuration (composition) that the injection unit 53 for forming fine particles is fixed (set) to the injector 52 which is the slightly modified conventional fuel injector, and therefore resulting in low costs and high reliability.

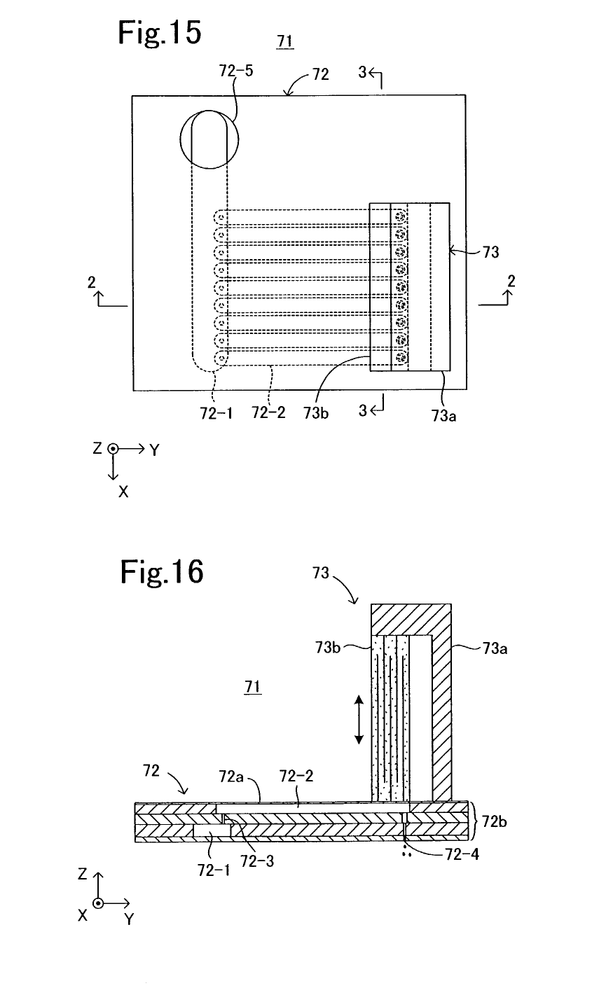

A liquid injection apparatus in accordance with a fifth embodiment of the present invention will then be described. This liquid injection apparatus adopts an injection unit 71 shown in FIG. 15 and FIG. 16 in place of the injection units in each of the embodiments described above. Note that FIG. 15 shows a plan view of the injection unit 71, and FIG. 16 shows a sectional view of the injection unit 71 taken along line 2-2 of FIG. 15.

This injection unit 71 comprises a flow passage forming section 72 and a pressurizing section 73. The flow passage forming section 72 has the same configuration (composition) as that of the flow passage forming section 14A of the injection unit 14 described above. That is, the flow passage forming section 72 comprises a liquid supply passage 72-1 inside, a plurality (herein nine) of chambers 72-2 being mutually independent, a plurality of liquid introduction holes 72-3 having each of the chambers 72-2 communicate with the liquid supply passage 72-1, a plurality of liquid ejection nozzles 72-4 having each of the chambers 72-2 communicate with an outer portion of the injection unit 71, and a liquid fill port 72-5.

Furthermore, the flow passage forming section 72 is formed of zirconia ceramics, except for an upper wall (wall surface) 72a of the each chambers 72-2. Hereinafter, the part formed of the ceramics will also be referred to as a ceramic sheet portion 72b. The upper wall 72a forming the upper wall surface of the chambers 72-2 functions as a diaphragm similarly to the ceramic sheet 14f of the injection unit 14, and is made of stainless steel in this case. The upper wall 72a is bonded and fixed on the upper portion (surface) of the ceramic sheet portion 72b.

The pressurizing section 73 comprises a fixing section 73a and a piezoelectric/electrostrictive element section 73b. The fixing section 73a is a rigid body having an inverted L sectional shape and its undersurface, being one end surface, is fixed on the top surface of the upper wall 72a of the flow passage forming section 72 in a position which is not right above the chamber 72-2. The fixing section 73a fixes and holds the piezoelectric/electrostrictive element section 73b at its upper portion (lower side surface of the upper portion).

The piezoelectric/electrostrictive element section 73b has a substantially rectangular parallelepiped shape whose sides extend in parallel with the corresponding orthogonal X, Y, and Z axes, and is a “layered piezoelectric actuator” which is formed by layering alternately a plurality of the layered piezoelectric/electrostrictive elements and a plurality of layered electrodes.

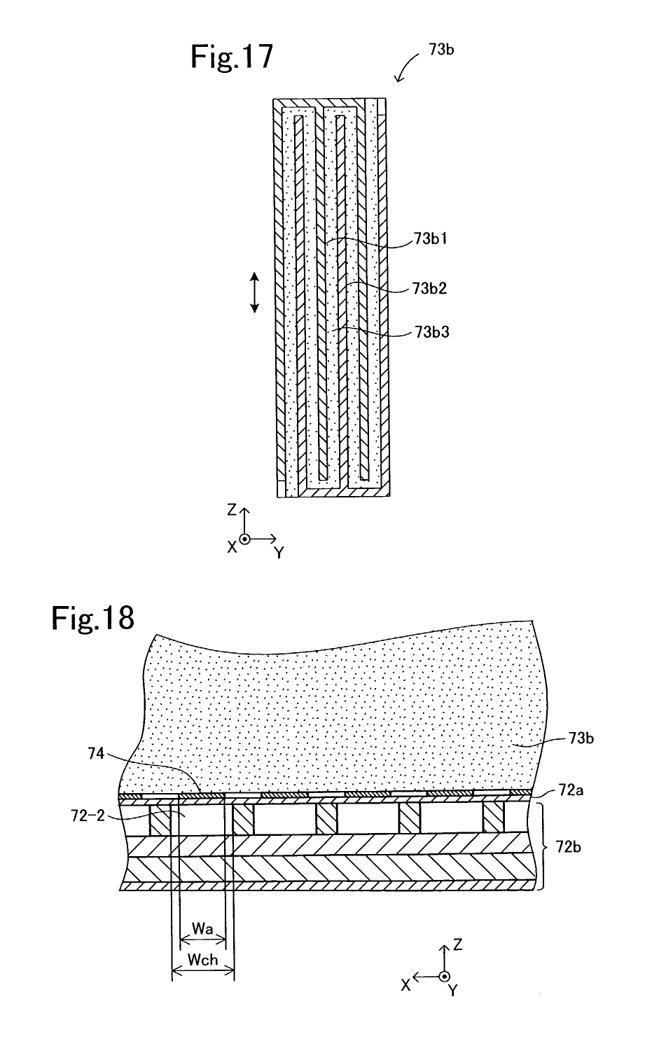

The piezoelectric/electrostrictive element section 73b comprises a comb-tooth-like electrode 73b1, a comb-tooth-like electrode 73b2, and a plurality of layered piezoelectric/electrostrictive elements (piezoelectric/electrostrictive material) 73b3, as shown in FIG. 17 of a sectional view. Each of the comb-tooth-like electrodes 73b1 and 73b2 comprises a plurality of electrode fingers which extend along planes parallel to the X-Z plane with having equal intervals to each other. Each of the electrode fingers is connected to common electrode sections formed on planes parallel to the X-Y plane. The electrode fingers of the comb-tooth-like electrodes 73b1 and 73b2 are arranged alternately opposite to each other. Each of the layered piezoelectric/electrostrictive elements 73b3 is formed between the opposed electrode fingers.

The undersurface of the piezoelectric/electrostrictive element section 73b is bonded and fixed on the top surface of the upper wall (diaphragm) 72a by a layer comprising an adhesive (bonding layer) at the upper portion of the chamber 72-2, the upper portion being in the vicinity of the end portion of the fixing section 73a (in the vicinity of right upper portion of the liquid ejection nozzles 72-4). As shown in FIG. 18, which shows an enlarged sectional view of the injection unit 71 taken along line 3-3 of FIG. 15, the adhesive layer 74 is formed between the upper wall 72a of the chamber 72-2 and the undersurface of the piezoelectric/electrostrictive element section 73b, and the length (width Wa) of a side of each adhesive layer 74 extending along the X axis direction is slightly shorter than the length (width Wch) of a side of each chamber 72-2 extending along the X axis direction.

In the injection unit configured as described above, when positive and negative voltages by the drive voltage signal are given across the comb-tooth-like electrodes 73b1 and 73b2 of the piezoelectric/electrostrictive element section 73b alternately in terms of time, the piezoelectric/electrostrictive element section 73b shrinks and expands in a direction (vertical direction, Z axis direction, direction parallel to the plane of the piezoelectric/electrostrictive element 73b3) indicated by arrows in FIG. 16 and FIG. 17. That is, the piezoelectric/electrostrictive element section 73b is called a vertical effect type. Since the upper wall 72a of the chamber 72-2 is pressed and deformed by the shrinking and expanding of the piezoelectric/electrostrictive element section 73b, the capacity of the chamber 72-2 changes. This transmits the vibrations to the liquid in the chamber 72-2, and thus the liquid injected from the liquid ejection nozzle 72-4 is atomized (formed into fine particles).

As described above, the liquid injection apparatus in accordance with the fifth embodiment has a structure that the undersurface of the piezoelectric/electrostrictive element section 73b of the pressurizing section 73 in the injection unit 71 is fixed by adhesion onto the upper wall 72a which is the diaphragm of the flow passage forming section 72, so that the upper wall 72a does not need to be ceramics that enables the piezoelectric/electrostrictive element section 73b to be integrated by burning. Therefore, the diaphragm 72a can be formed of a material, such as a metal (stainless steel in this example), that is appropriate in terms of tenacity for forming the liquid to be injected into fine particles by vibrations.

Furthermore, in the present injection unit 71, since the piezoelectric/electrostrictive element section 73b is not integrally burnt onto the upper wall 72a unlike the injection unit 14 in other embodiments, the material forming the piezoelectric/electrostrictive element section 73b does not permeate (invade) into the upper wall 72a when burnt. Thus, the material forming the piezoelectric/electrostrictive element section 73b does not deteriorate characteristics such as tenacity of the upper wall 72a. As a result, it is possible to provide the injection unit 71 having excellent durability.

Still further, according to the liquid injection apparatus in the fifth embodiment, since the “multilayered piezoactuator of a vertical effect type” is adopted for the piezoelectric/electrostrictive element section 73b of the pressurizing section 73 of the injection unit 71, the force (deforming force, pressurizing force) to deform the upper wall 72a can be relatively large and the upper wall 72a can be greatly deformed, even if the voltage given across the comb-tooth-like electrodes 73b1 and 73b2 is relatively low, thereby power consumption by the liquid injection apparatus can be reduced. In addition, the deforming force can also be made large by enlarging the piezoelectric/electrostrictive element section 73b in a vertical direction (Z axis direction).

It is apparent from the foregoing description that the upper wall 72a can be deformed as much as desired and the capacity variation ΔV of the chamber 72-2 can be large, even if the rigidity of the upperwall 72a becomes larger when the length of the major axis of the chamber 72-2 (length in the Y axis direction) and/or the length of the minor axis (length in the X axis direction) are/is reduced. This makes it possible to reduce the area of an injection surface of the injection unit 71 on which the eject ports of the liquid ejection nozzle 72-4 is formed (i.e. the area of the undersurface (X-Y plane) of the flow passage forming section 72). Also, this makes it possible to reduce the distance between the eject ports of each of the liquid ejection nozzles 72-4 (i.e. the distance of the adjacent eject ports in the X axis direction). As a result, according to the present liquid injection apparatus, for example, the injection surface from which the liquid (gasoline) is injected can be placed in a proper (desired) position of an introduction system (intake system) of the internal combustion engine, and high-density liquid droplets of gasoline atomized can be injected at a proper (desired) region of the introduction system of the engine.

Further, the force for deforming generated by the piezoelectric/electrostrictive element section 73b can be efficiently transmitted to the upper wall 72a functioning as the diaphragm of each chamber 72-2, since the length (width Wa) of the side in the X axis direction of each adhesive layer 74 is slightly shorter than the length (width Wch) of the side in the X axis direction of each chamber 72-2. Therefore, the upper wall 72a can certainly be deformed even with a little force, so that the capacity of each chamber 72-2 is certainly changed, thereby the atomization of the injected liquid can be certainly achieved.

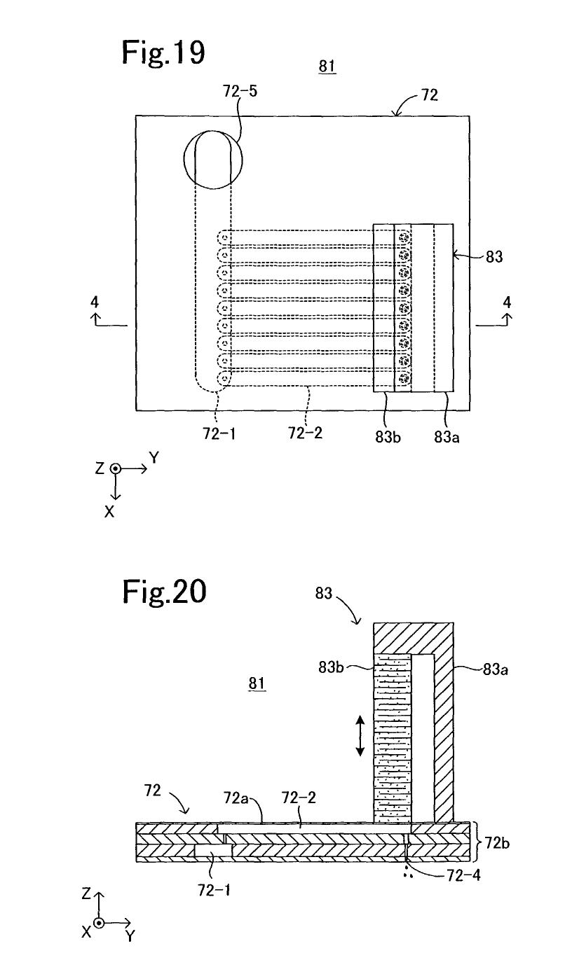

A liquid injection apparatus in accordance with a sixth embodiment of the present invention will then be described. This liquid injection apparatus adopts an injection unit 81 shown in FIG. 19 and FIG. 20 in place of the injection units in each of the above embodiments. Note that FIG. 19 shows a plan view of the injection unit 81, and FIG. 20 shows a sectional view of the injection unit 81 taken along line 4-4 of FIG. 19.

The injection unit 81 comprises a flow passage forming section identical to the flow passage forming section 72 of the injection unit 71, and a pressurizing section 83. The pressurizing section 83 comprises a fixing section 83a identical to the fixing section 73a of the injection unit 71 and a piezoelectric/electrostrictive element section 83b. This means that the injection unit 81 is different from the injection unit 71 only in that the piezoelectric/electrostrictive element section 73b of the injection unit 71 is replaced with the piezoelectric/electrostrictive element section 83b. Therefore, hereinafter, the piezoelectric/electrostrictive element section 83b will be described in detail.

The piezoelectric/electrostrictive element section 83b is a “multilayered piezoactuator of a horizontal effect type” which is formed by layering alternately a plurality of the layered piezoelectric/electrostrictive elements and a plurality of layered electrodes.

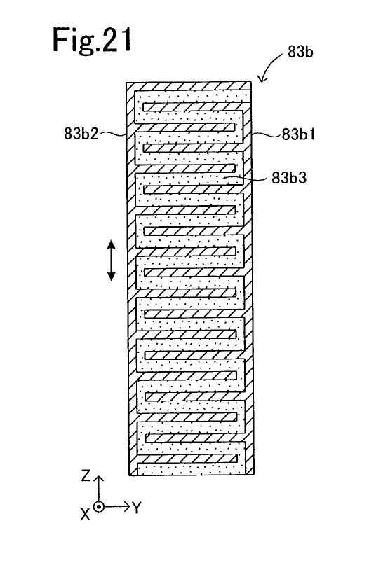

The piezoelectric/electrostrictive element section 83b comprises a comb-tooth-like electrode 83b1, a comb-tooth-like electrode 83b2, and a plurality of layered piezoelectric/electrostrictive elements 83b3, as shown in FIG. 21 of a sectional view. Each of the comb-tooth-like electrodes 83b1 and 83b2 comprises a plurality of electrode fingers which extend along planes parallel to the X-Y plane with having equal intervals to each other. These fingers extend from common electrodes section formed on planes parallel to the X-Z plane. The electrode fingers of the comb-tooth-like electrodes 83b1 and 83b2 are arranged alternately opposite to each other. Each of the layered piezoelectric/electrostrictive elements 83b3 is formed between the opposed electrode fingers.

In the injection unit 81 configured as described above, when positive and negative voltages by the drive voltage signal are given across the comb-tooth-like electrodes 83b1 and 83b2 of the piezoelectric/electrostrictive element section 83b alternately in terms of time, the piezoelectric/electrostrictive element section 83b shrinks and expands in a direction (vertical direction, Z axis direction) indicated by arrows in FIG. 20 and FIG. 21, that is, in a direction orthogonal to the plane of the piezoelectric/electrostrictive element section 83b. Since the upper wall 72a of the chamber 72-2 is pressed and deformed by the shrinking and the expansion of the piezoelectric/electrostrictive element section 83b, the capacity of the chamber 72-2 changes. This transmits the vibrations to the liquid in the chamber 72-2, and thus the liquid injected from the liquid ejection nozzle 72-4 is atomized (formed into fine particles).

According to the liquid injection apparatus of this sixth embodiment, the same effects can be obtained as that of the liquid injection apparatus of the fifth embodiment. That is, the undersurface of the piezoelectric/electrostrictive element section 83b of the pressurizing section 83 in the injection unit 81 is fixed by adhesion onto the upper wall 72a, so that the upper wall 72a can be formed of a material appropriate in terms of tenacity for forming the liquid to be injected into fine particles by vibrations.

In addition, since the piezoelectric/electrostrictive element section 83b is the “multilayered piezoactuator of a horizontal effect type”, the force (deforming force, pressurizing force) to deform the upper wall 72a can be relatively large and the upper wall 72a can be greatly deformed, even if the voltage given across the comb-tooth-like electrodes 83b1 and 83b2 is relatively low, thereby power consumption by the liquid injection apparatus can be reduced. In addition, the deforming force can also be made large by enlarging the piezoelectric/electrostrictive element section 83b in a vertical direction (Z axis direction).

Accordingly, in the liquid injection apparatus in accordance with the present embodiment, it is apparent from the foregoing description that the upper wall 72a can be deformed as much as desired and the capacity variation ΔV of the chamber 72-2 can be large, even if the rigidity of the upper wall 72a becomes larger when the length of the major axis of the chamber 72-2 (length in the Y axis direction) and/or the length of the minor axis (length in the X axis direction) are/is reduced. Therefore, for the same reason as that of the fifth embodiment, the area of the injection surface of the injection unit 81 can be reduced.

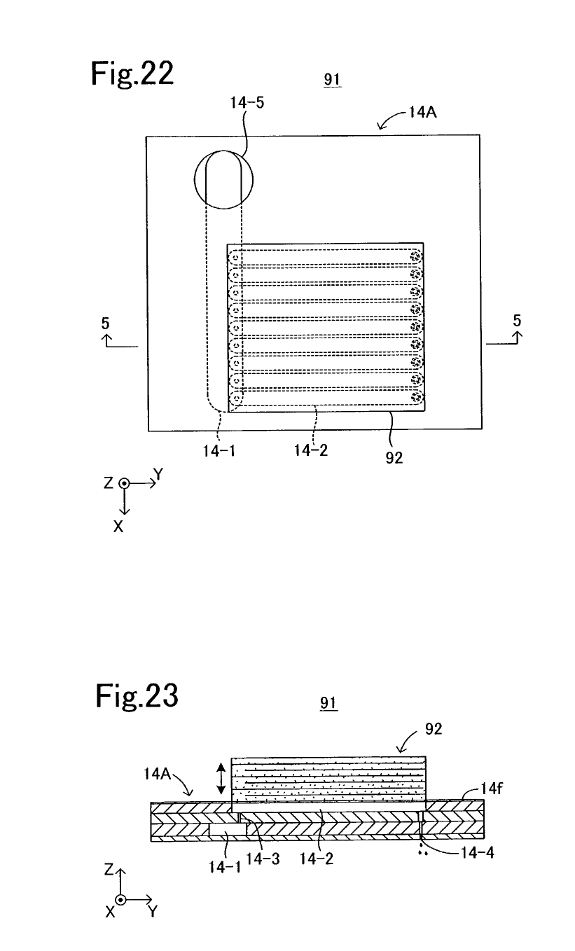

A liquid injection apparatus in accordance with a seventh embodiment of the present invention will then be described. This liquid injection apparatus adopts an injection unit 91 shown in FIG. 22 and FIG. 23 in place of the injection units in each of the above embodiments. Note that FIG. 22 shows a plan view of the injection unit 91, and FIG. 23 shows a sectional view of the injection unit 91 taken along line 5-5 of FIG. 22.

This injection unit 91 comprises a flow passage forming section identical to the flow passage forming section 14A of the injection unit 14, and a pressurizing section 92. The pressurizing section 92 is a piezoelectric/electrostrictive element section, and has a substantially rectangular parallelepiped shape whose sides extend in parallel with the corresponding orthogonal X, Y, and Z axes. The pressurizing section 92 is a “multilayered piezoactuator” which is formed by layering alternately a plurality of the layered piezoelectric/electrostrictive elements and a plurality of layered electrodes. That is, the pressurizing section 92 has the same structure as the one shown in FIG. 21 in which length in the Z axis direction of the piezoelectric/electrostrictive element section 83b is shortened and the length in the Y axis direction is elongated.

The length in theY axis direction of the pressurizing section 92 is much the same as or slightly shorter than the length in the Y axis direction of the chamber 14-2, and the length in the X axis direction is slightly longer than the distance between one chamber 14-2 positioned at an end portion in the X positive direction and one chamber 14-2 positioned at an end portion in the X negative direction. The undersurface of the pressurizing section 92 is integrally joined, at upper portion of the chamber 14-2, by burning onto the top surface of the ceramic sheet 14f serving as the upper wall of the chamber.

In the injection unit 91 configured as described above, when positive and negative voltages by the drive voltage signal are given across a pair of the comb-tooth-like electrodes of the pressurizing section 92 alternately in terms of time, the pressurizing section 92 operates in the same manner as the piezoelectric/electrostrictive element 14g of the injection unit 14 to deform the ceramic sheet 14f and changes the capacity of the chamber 14-2 by ΔV. This transmits the vibrations to the liquid in the chamber 14-2, and thus the liquid injected from the liquid ejection nozzle 14-4 is atomized (formed into fine particles).

As described above, according to the liquid injection apparatus in the seventh embodiment, since the pressurizing section 92 is the multilayered piezoactuator, much displacement (a large amount of change in capacity of the chamber) can be obtained with a low voltage as compared with the injection unit 14, thereby resulting in the lower power consumption of the liquid injection apparatus.

In the liquid injection apparatus in the seventh embodiment described above, the ceramic sheet 14f may be replaced with the upper wall 72a in the fifth embodiment, and the undersurface of the pressurizing section 92 may be joined by adhesion onto the top surface of the upper wall 72a. According to this modification, similarly to the fifth and sixth embodiments, the upper wall 72a can be formed of a material such as a metal (stainless steel in this example) that is appropriate in terms of tenacity for forming the liquid into to be injected into fine particles by vibrations. In this case, as shown in FIG. 18, it is preferable that the adhesive layer is provided only within the immediate upper portion of the chamber 14-2.

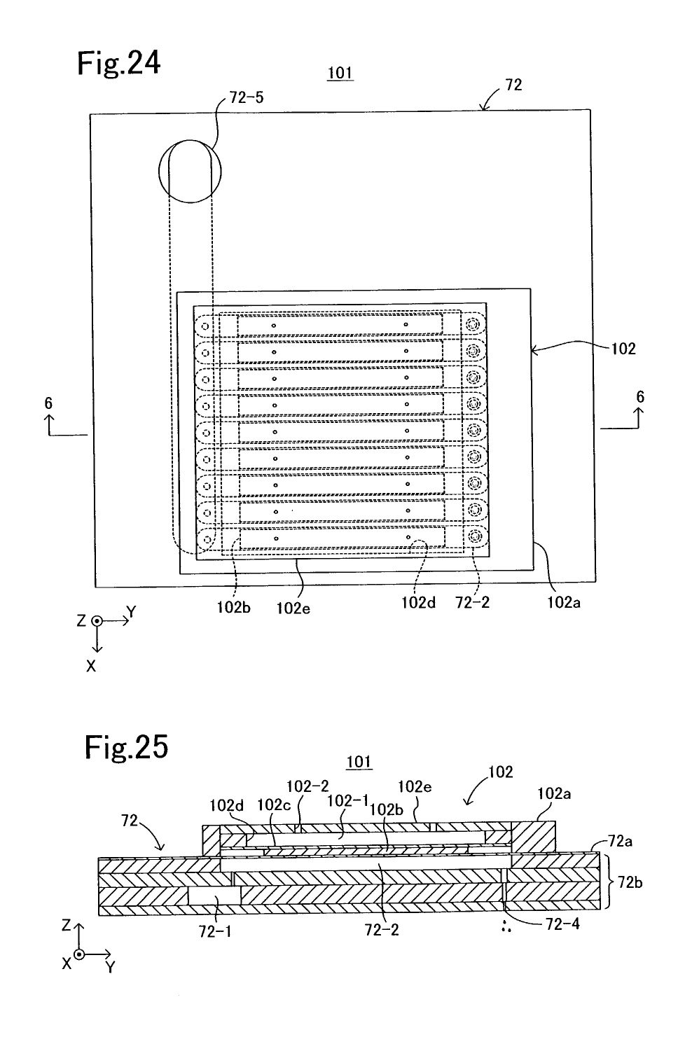

A liquid injection apparatus in accordance with an eighth embodiment of the present invention will then be described. This liquid injection apparatus adopts an injection unit 101 shown in FIG. 24 and FIG. 25 in place of the injection units in each of the above embodiments. Note that FIG. 24 shows a plan view of the injection unit 101, and FIG. 25 shows a sectional view of the injection unit 101 taken along line 6-6 of FIG. 24.

This injection unit 101 comprises a flow passage forming section identical to the flow passage forming section 72 of the injection unit 71, and a pressurizing section 102. The pressurizing section 102 comprises a fixing section 102a, a plurality of piezoelectric/electrostrictive element sections 102b, a piezoelectric/electrostrictive element holding section 102c, spacer section 102d and a cover section 102e. This injection unit 101 has a substantially rectangular parallelepiped shape whose sides extend in parallel with the corresponding orthogonal X, Y, and Z axes as a whole.

As shown in FIG. 24, the fixing section 102a is a rectangular frame of which outer circumferential shape and inner circumferential shape have sides extending along X axis and Y axis in a plan view, and its undersurface is bonded to the upper surface of the upper wall 72a. The length of one side along Y axis of the inner circumferential shape of the fixing section 102a is substantially equal to the length in the Y axis direction of the chamber 72-2 of the flow passage forming section 72, and the other side of length along X axis direction is slightly longer than the distance between one chamber 72-2 positioned at an end portion in the X positive direction and one chamber 72-2 positioned at an end portion in the X negative direction.

The piezoelectric/electrostrictive element sections 102b is a thin plate (laminate) which has a rectangular shape in a plan view. Its width (length in the X axis direction) of the rectangular is almost the same as or slightly shorter than the width (length in the X axis direction) of the chamber 72-2, and its length (length in the Y axis direction) of the rectangular is slightly shorter than the length (length in the Y axis direction) of the chamber 72-2. The number of the piezoelectric/electrostrictive element sections 102b is the same as that of the chambers 72-2. The piezoelectric/electrostrictive element sections 102b are disposed in a manner that each of them overlaps each of the chambers 72-2 at a central portion in the Y axis direction of each chamber 72-2 and above each of the chamber (i.e., the piezoelectric/electrostrictive element sections 102b are disposed in such a manner that each of their major axes and each of the major axes of the chambers are substantially on the same line, in a plan view). The undersurface of the piezoelectric/electrostrictive element section 102b is bonded to the upper surface of the upper wall 72a of the flow passage forming section 72.

The piezoelectric/electrostrictive element holding section 102c is a ceramic plate (zirconia board) having a rectangular shape in a plan view, and its outer circumferential shape is substantially the same as the inner circumferential shape of the fixing section 102a. This piezoelectric/electrostrictive element holding section 102c integrally joins, at its lower surface, the piezoelectric/electrostrictive element section 102b by burning. The piezoelectric/electrostrictive element holding section 102c does not need to be a rigid body, but has rigidity higher than the rigidity of the upper wall 72a of the flow passage forming section 72.

The spacer section 102d is a rectangular frame of which outer circumferential shape and inner circumferential shape have sides extending along X axis and Y axis in a plan view. The outer circumferential shape of the spacer section 102d has the same shape as the inner circumferential shape of the fixing section 102a. The inner circumferential shape of the spacer 102d is larger than the shape of an outline of the piezoelectric/electrostrictive element section 102b in a plan view so that both shapes do not overlap. The spacer section 102d is disposed above the piezoelectric/electrostrictive element holding section 102c, and inside the fixing section 102a.

The cover section 102e is a board having high rigidity of which outer circumferential shape is the same as the inner circumferential shape of the fixing section 102a in a plan view, and is positioned above the spacer 102d and inside the fixing section 102a. As a result, in the upper part of the piezoelectric/electrostrictive element section 102b, an air gap section 102-1 is formed which is defined by the piezoelectric/electrostrictive element holding section 102c, the spacer section 102d, and the cover section 102e. The ceramic plate, which is the piezoelectric/electrostrictive element holding section 102c, is fixed immovably to the flow passage forming section 72 with a certain distance from the upper wall 72a of the chamber 72-2 when the upper wall 72a of the chamber 72-2 is not deformed. The piezoelectric/electrostrictive element section 102b is hermetically stuck and disposed between the ceramic plate 102c and the upper wall 72a. The cover section 102e is provided with a plurality of through-holes 102-2 so that air comes in and out of the air gap 102-1 when the capacity of the air gap 102-1 varies.

The fixing section 102a, the piezoelectric/electrostrictive element holding section 102c, the spacer section 102d and the cover section 102e are formed of ceramics, and integrated by burning.

According to the injection unit 101 of the liquid injection apparatus in accordance with the eighth embodiment, the piezoelectric/electrostrictive element section 102b integrally joined by burning to the piezoelectric/electrostrictive element holding section 102c of the ceramic plate repeatedly presses the upper wall 72a of the chamber that functions as a diaphragm by means of piezoelectric/electrostrictive element section 102b. This changes the capacity of the chamber 72-2 to form the liquid to be injected into fine particles.

Here, since parts that are substantially relating to the vibrations caused by the piezoelectric/electrostrictive element section 102b include the chamber 72-2, the upper wall 72a serving as the diaphragm, the piezoelectric/electrostrictive element section 102b and the piezoelectric/electrostrictive element holding section 102c, and the rigidity of the piezoelectric/electrostrictive element holding section 102c is higher than the rigidity of the upper wall 72a, the resonance frequency of the parts comprised of these parts relating to the vibrations is increased and become larger than the resonance frequency of the parts relating to the vibrations in the injection unit 14.

Incidentally, in general, if the upper wall (diaphragm) 72a (upper wall surface to be deformed of the chamber 72-2) functioning as the diaphragm is vibrated at the frequency lower than the resonance frequency of the parts relating to the vibrations of the diaphragm 72a, the diaphragm 72a is deformed only from a nodal line (line of intersection) of (between) the diaphragm 72a and other walls of the chamber 72-2. In other words, the diaphragm 72a is deformed from upper corner of the chamber 72-2 located at Z axis positive direction. That is, the diaphragm 72a is deformed in such a manner that it has a single abdomen. As a result, the vibrations necessary to inject the liquid in the chamber 72-2 as fine particles having a desired particle diameter can certainly be added to the liquid.

Contrary to this, if the diaphragm 72a is vibrated at a frequency higher than the resonance frequency of the parts substantially relating to the vibrations, the diaphragm 72a is deformed in such a manner that it has a plurality of wave fronts, and it will be difficult to properly add to the liquid the vibrations for forming the injected liquid into the fine particles having a desired particle diameter.

As apparent from the above description, according to the configuration of the injection unit 101 in accordance with the eighth embodiment, since the resonance frequency of the parts substantially relating to the vibrations caused by the piezoelectric/electrostrictive element section 102b is raised, it is possible to certainly form the liquid into fine particles even if the upper wall 72a of the chamber 72-2 is vibrated at a higher frequency, thereby the particle diameter of the injected liquid can be made smaller. Alternatively, even when the pressure (ejecting pressure) generated by the pressurizing pump 11 serving as the pressurizing means is heightened to increase the injection amount per unit time, the liquid can certainly be atomized by vibrating the upper wall 72a of the chamber 72-2 at the higher frequency up to the heightened frequency mentioned above. Therefore, it becomes possible to supply a large amount of the liquid which is atomized, according to the present embodiment.

It is noted that, in the injection unit 101, the cover section 102e is provided, however, this cover section 102e may be omitted.

Further, it is also noted that the higher the rigidity of the piezoelectric/electrostrictive element holding section 102c is, the higher the resonance frequency becomes. It is therefore preferable that the piezoelectric/electrostrictive element holding section 102c has higher rigidity, for example, by increasing the thickness (length in the Z axis direction) of the piezoelectric/electrostrictive element holding section 102c.

Furthermore, also in the injection unit 101, the upper wall 72a and the piezoelectric/electrostrictive element section 102b are bonded. Therefore, unlike the injection unit that joins these by burning, the material forming the piezoelectric/electrostrictive element section 102b does not deteriorate characteristics such as tenacity of the upper wall 72a. In addition, as it is not necessary for the upper wall 72a and the piezoelectric/electrostrictive element section 102b to be made of the materials capable of being integrally burnt, the option of the material for the upper wall 72a is broadened (the material for the upper wall 72a is chosen from more variety of materials). These features make it possible to have the upper wall 72a with excellent durability against vibrations, and therefore, it is possible to improve the durability of the injection unit 101 (liquid injection apparatus). It is also noted that the piezoelectric/electrostrictive element section 102b may be the multilayered piezoactuator.

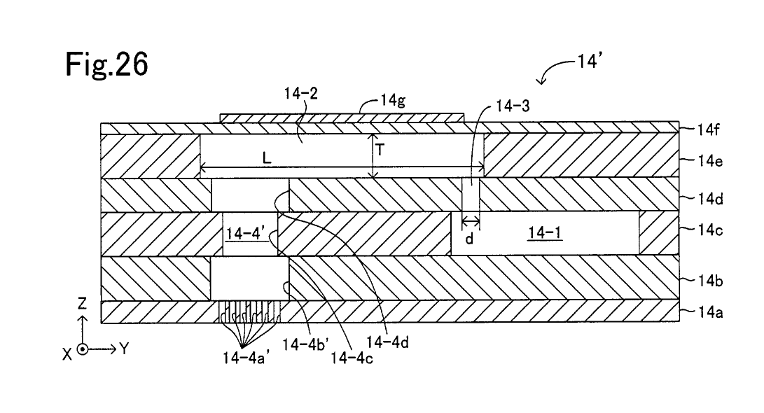

A liquid injection apparatus in accordance with a ninth embodiment of the present invention will then be described. This liquid injection apparatus adopts an injection unit 14′ which is obtained by modifying the injection unit 14, in place of the injection unit 14 described above. Therefore, hereinafter, the difference from the injection unit 14 will be mainly described with reference to FIG. 26 to FIG. 28.

In the injection unit 14 described above, only one communicating hole 14-4a serving as the liquid injection opening is provided to each of the chambers 14-2, and the liquid ejection nozzle 14-4 comprises the liquid injection opening 14-4a and the hollow cylindrical communicating holes 14-4b to 14-4d that are formed in ceramic sheets 14b to 14d whose sizes (diameters) become larger in order from the liquid injection opening 14-4a to the chamber 14-2, respectively. The shape of the liquid injection opening 14-4a is circular.

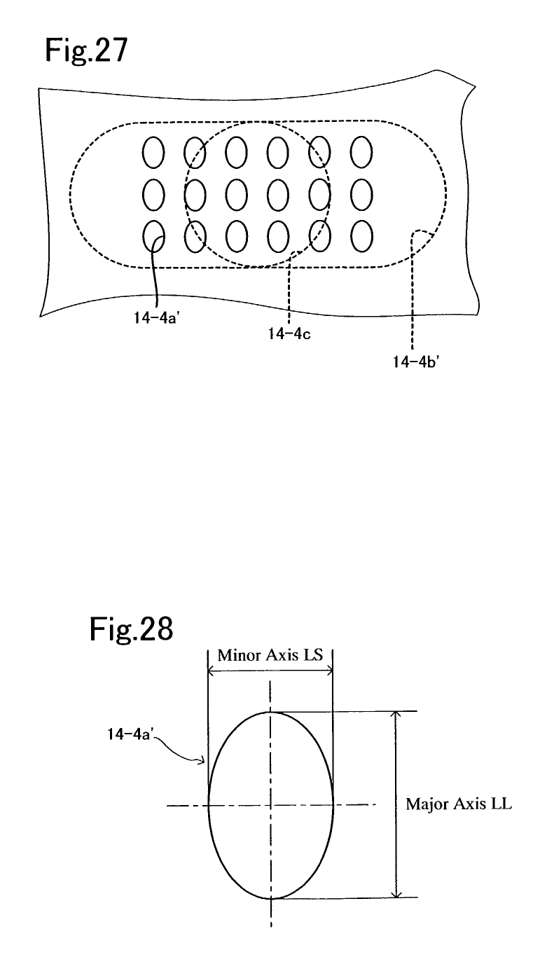

Contrary to this, in the injection unit 14′ according to the ninth embodiment, the liquid ejection nozzle 14-4′ comprises (or is formed of) the hollow cylindrical communicating hole 14-4d provided in the ceramic sheet 14d, the hollow cylindrical communicating hole 14-4c provided in the ceramic sheet 14c that is coaxial with the communicating hole 14-4d and has a diameter smaller than that of the communicating hole 14-4d, a hollow columnar communicating hole 14-4b′ that is coaxial with the communicating hole 14-4c and is provided in the ceramic sheet 14b, and a plurality (in this example, three rows times six lines equals 18 in total) of hollow columnar communicating holes 14-4a′ . . . 14-4a′, each communicating with the communicating hole 14-4b′. The communicating hole 14-4b′ has an oval section as shown in FIG. 27. Each cavity (chamber) 14-2 communicates with a plurality of liquid injection openings 14-4a′. As shown in FIG. 27 showing a magnified front view of the liquid injection openings 14-4a′, the length of the minor axis of the communicating hole 14-4b′ is equal to the diameter of the communicating hole 14-4c. As shown in FIG. 28 showing a magnified front view of one of the liquid injection openings 14-4a′, the sectional shape of the communicating hole 14-4a′ (shape of the liquid injection opening) is elliptic, whose length of the major axis is LL and length of the minor axis is LS.

The communicating hole 14-4a′ having the elliptic sectional shape described above can be formed by an electron beam method, a punching method, a laser processing method or the like. In this case, the laser processing method is preferable as the focal point is easily adjusted and the targeted elliptic shape is certainly obtained. Especially, it is more preferable to adopt the process using a third higher harmonic wave and a fourth higher harmonic wave of a YAG laser in order to form the communicating hole 14-4a′, because such process can reduce the beam diameter as small as required when making minute holes.

In this example, by using the fourth higher harmonic wave of the YAG laser, with repetitive transmission frequency 2 kHz and laser power 1 mW, the communicating hole 14-4a′ having a major axis LL=0.007 mm and a minor axis LS=0.005 mm is formed in an object to be processed, which is made of partially stabilized zirconia and has a thickness of 0.01 mm (i.e., the ceramic sheet 14a in which the communicating hole 14-4a′ is to be formed).

Experiments were conducted in which the liquid injection apparatus 10 in accordance with the ninth embodiment having configurations as above was applied to the internal combustion engine for injecting (spraying) gasoline into the suction pipe (the intake pipe) 20. At the same time, experiments were conducted to compare the performance of the apparatus 10 above with one having the circular liquid injection opening. The results of the experiment are shown in Table 2. In this experiment, a phase Doppler laser particle analyzing device was used to measure the average particle diameter of 10,000 injected liquid droplets.

TABLE 2

| Shape and size of | Average particle |
|---|---|
| Liquid injection openings | diameter |
| Circular | 0.012 mm |
| Diameter 0.007 mm | |
| Elliptic | 0.009 mm |
| Major axis LL = 0.008 mm | |
| Minor axis LS = 0.006 mm | |

Furthermore, the ejected flow volume (injected flow amount) of the fuel in the experiments whose results are shown in Table 2 above is shown in Table 3.

TABLE 3

| Shape and size of | |
|---|---|
| Liquid injection openings | Flow volume |
| Circular | 165 cc/minute |
| Diameter 0.007 mm | |
| Elliptic | 198 cc/minute |
| Major axis LL = 0.008 mm | |
| Minor axis LS = 0.006 mm | |

As apparent from Table 2, if the shape of the liquid injection opening (i.e. sectional shape of the communicating hole 14-4a′) is elliptic, the average diameter of the injected liquid droplets (particles) becomes smaller, compared with the case where the shape of the liquid injection opening is a circular shape having about the same sectional area as the area of the elliptic shape.

The following reasons for these results can be inferred. That is, if the shape of the liquid injection opening is made elliptic to have the same opening area as in the case where the shape of the liquid injection opening is a circle having the predetermined diameter D, the minor axis LS of the ellipse is shorter than the diameter D of the circle, and therefore, the minimum diameter of the constriction of the ejected liquid caused by the vibrations added to the liquid in the chamber becomes smaller than that in the case where the shape of the liquid injection opening is circular. Further, liquid has properties of becoming spherical by surface tension in space. Therefore, liquid ejected (injected) from the elliptic liquid injection opening separates more easily at (from) the minimum diameter portion (i.e. the constriction portion) that is smaller than the minimum diameter in the case where the shape of the liquid injection opening is circular, and becomes spherical fine particles having a diameter smaller than a diameter of particles obtained in the case where the shape of the liquid injection opening is circular.

It is also apparent from Table 2 and Table 3 that, if the shape of the liquid injection opening is elliptic, the ejected liquid volume (i.e. injection amount per unit time) can be increased while the particle diameter of the ejected liquid is kept the same as or smaller than the particle diameter in the case where the shape of the liquid injection opening is circular. In other words, in order to make the particle diameter of the liquid ejected from the injection opening having the elliptic shape equal to the particle diameter of the liquid ejected from the injection opening having the circular shape whose diameter is D, the minor axis length LS of the elliptic shape of the liquid injection opening can be almost equal to the diameter D. Accordingly, because the major length LL of the elliptic shape can be larger than the diameter D of the circular shape, the area of the liquid injection opening can be larger, and therefore, the volume of the injected liquid (eject flow volume) can be increased.

Furthermore, under a condition in which the liquid droplets having an equal diameter to each other are injected, since the major axis length LL of the liquid injection opening having the elliptic shape can be made larger than the diameter D of the liquid injection opening having the circular shape, it is possible to remove a lot of lint-like foreign objects (dust) contained in the liquid (liquid fuel) more easily. Accordingly, clogging of the eject nozzle can be avoided by having the elliptic liquid opening. It should be noted that a ratio (LL/LS) of the major axis length LL to the minor axis length LS when the liquid injection opening is elliptic is preferably 1.5 or more.

Next, another experiments were conducted. In the experiments, the state of atomization was observed when the liquid (fuel) was injected by the injection apparatus comprising a plurality of liquid injection openings for one cavity (chamber) 14-2 as in the injection unit 14′ of the ninth embodiment while changing the liquid pressure (pressurizing force) in the cavity 14-2. The results are shown in Table 4. The liquid injection opening in the unit used in this experiment has the elliptic shape whose major axis is 0.007 mm and whose minor axis is 0.005 mm. One cavity is provided with 18 liquid injection openings, and the number of the cavities is 300 in total. This means that the total of the liquid injection openings is 5400 (=18×300).

TABLE 4

| | Fuel pressure | | | | |
|---|---|---|---|---|---|
| | 0.20 | 0.25 | 0.30 | 0.35 | 0.45 |
| Operating state | Mpa | Mpa | Mpa | Mpa | Mpa |
| Driving | X | ◯ | ◯ | ◯ | ◯ |
| piezoelectric/electostrictive | | | | | |
| element | | | | | |
| Without driving | X | X | Δ | ◯ | ◯ |
| piezoelectric/electrostrictive | | | | | |
| element | | | | | |

◯: Atomization is stable.
Δ: Atomization is unstable. Occasionally, liquid droplets having a large particle diameter that are not atomized are generated.
X: No atomization is seen. The liquid drops from a surface (nozzle surface) on which the liquid injection opening is formed.

As apparent from Table 4, since it is possible to spray as desired at a lower pressure if one cavity is provided with a plurality of liquid injection openings, the power consumption by the pressurizing pump can be reduced. Further, the penetration force (speed in the moving direction) of the injected liquid can be decreased as it is possible to inject liquid droplets (spray) in a good atomization condition with a low pressure, thereby it becomes possible to reduce the amount of fuel adhering onto the wall surface of the suction pipe that forms the liquid injection space, to decrease fuel consumption of the internal combustion engine, and to reduce an amount of the undesirable exhaust gas from the internal combustion engine.

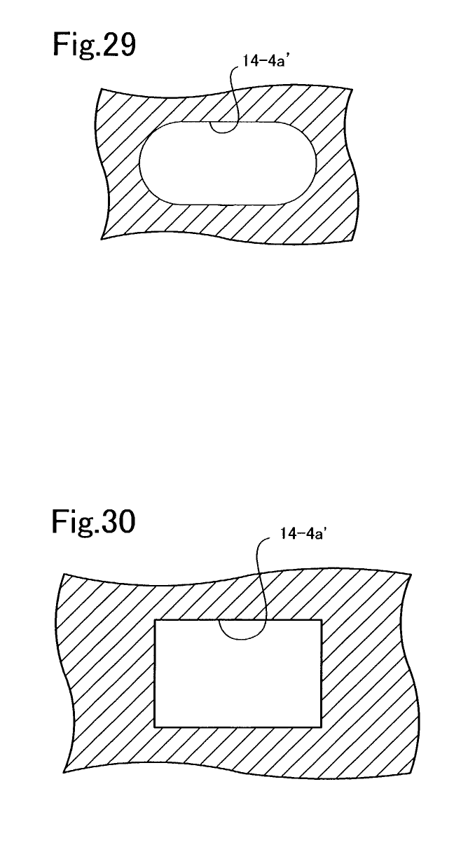

The shape of the liquid injection opening 14-4a′ (the shape of the liquid injection opening of the liquid ejection nozzle 72-4) as viewed from the axial direction of the liquid ejection nozzle does not need to be elliptic, and may have an oval shape (or an elongated circle) having a major axis and a minor axis as shown in FIG. 29, and also may be rectangular having a major axis (a longer side) and a minor axis (a shorter side) as shown in FIG. 30.

It is also possible in this case that the area of the oval or the area of the rectangle can be made equal to the area of the circle while the minor axis of the oval or the short side (minor axis) of the rectangle is made shorter than the diameter of the circle. Therefore, by making the shape of the liquid injection opening 14-4a oval or rectangular, the minimum diameter of the constriction of the ejected liquid caused by the vibrations added to the liquid in the chamber 14-2 becomes smaller compared with the case where the shape of the liquid injection opening 14-4a is circular. Thus, it becomes easier to form the liquid into finer particles since the liquid separates at (from) such a constriction portion having the smaller minimum diameter.

In other words, by making the shape of the liquid injection opening 14-4a (or the liquid injection opening of the liquid ejection nozzle 72-4) the shape having a minor axis and a major axis, such as the oval, an elongated circle, or the rectangle, the capacity variation ΔV of the chamber 14-2 (or the chamber 72-2) for forming the injected liquid into fine particles can be decreased, and thus, the displacement amount of the ceramic sheet 14f (or the upper wall 72a) serving as the diaphragm, the displacement being caused by the piezoelectric/electrostrictive element 14g (or the pressurizing sections 73, 83, 92 and 102), can be decreased. As a result, the liquid can be atomized (can be formed into fine particles as desired) even if the voltage of the drive voltage signal applied to the piezoelectric/electrostrictive element 14g (or the pressurizing sections 73, 83, 92 and 102) is low, and therefore the power consumption of the injection unit can be reduced.

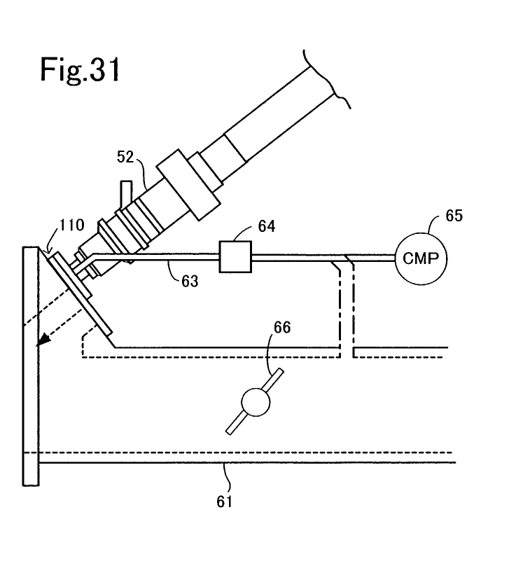

A liquid injection apparatus in accordance with a tenth embodiment of the present invention will then be described. This liquid injection apparatus is fixed to the suction pipe 61 that is the intake passage of the internal combustion engine and forms the liquid injection space as shown in FIG. 31. This liquid injection apparatus comprises the fuel injector 52 for injecting fuel as described with reference to FIG. 10, an air pipe 63 forming an air passage, an electromagnetic open-close valve 64 interposed in the air pipe 63, a compressor 65, and an injection unit 110 for forming liquid into fine particles that uses the piezoelectric/electrostrictive element. The injector 52 comprises a needle valve for opening an internal fuel passage when an injector driving signal is turned “ON” (high level). This fuel passage is supplied with the fuel from the liquid storage tank (not shown). The pressure of the fuel supplied to the fuel passage is adjusted by the pressure regulator (not shown).

The injection unit 110 not only injects atomized liquid (liquid fuel) into the liquid injection space 21, but also injects gas (air) into the liquid injection space 21. The liquid injection direction (main axis of the liquid injection direction) and the gas injection direction (main axis of the gas injection direction) are parallel to each other.

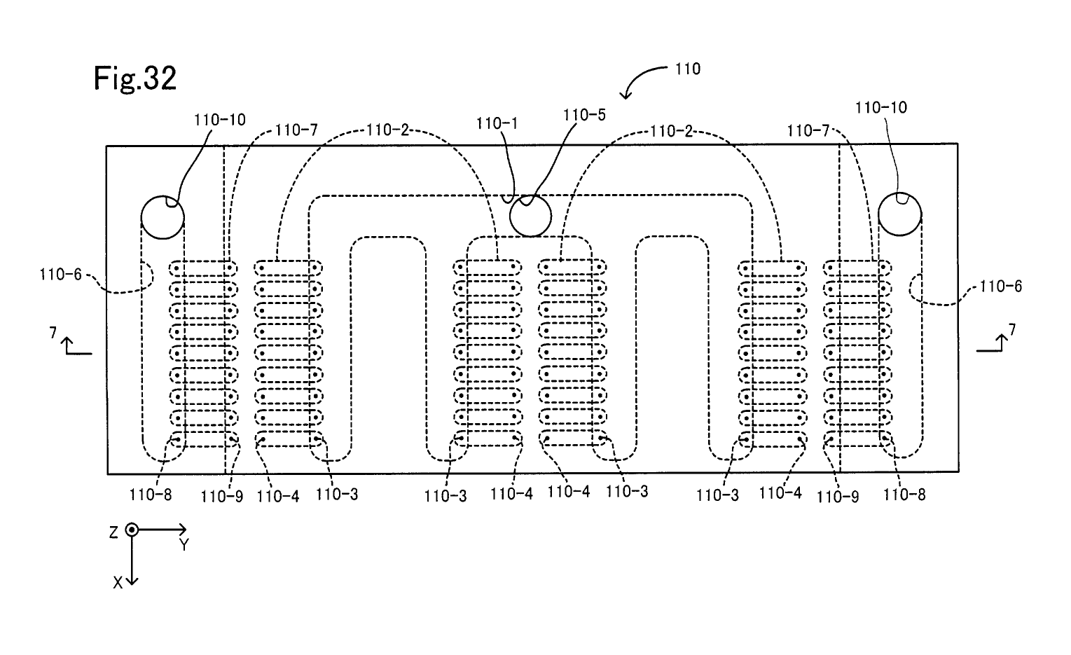

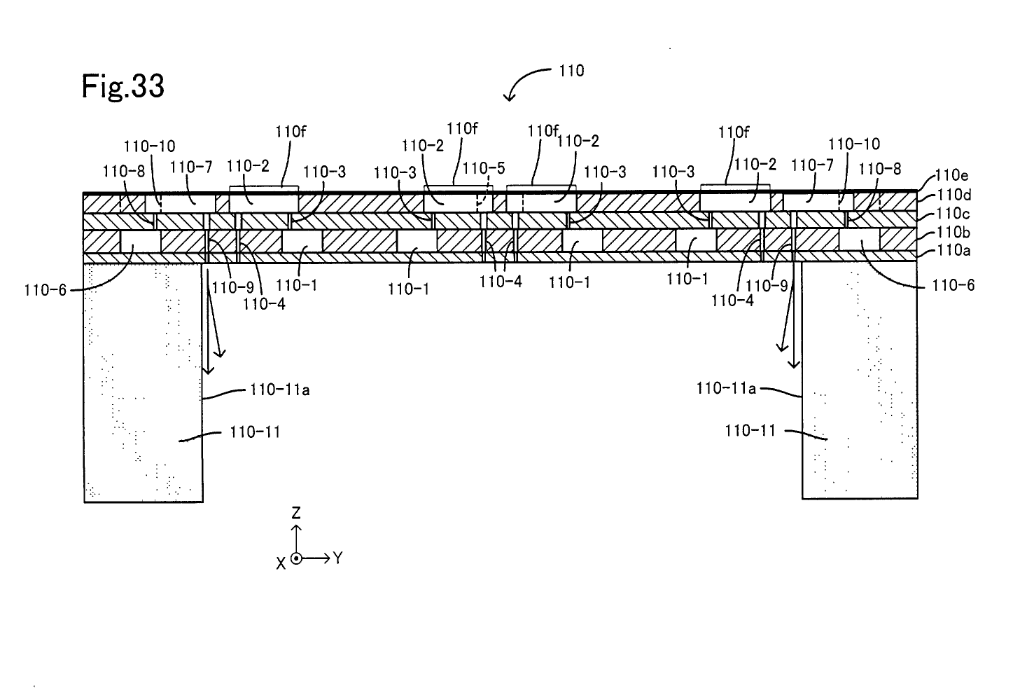

More specifically, this injection unit 110 has a substantially rectangular parallelepiped shape whose sides extend in parallel with the corresponding orthogonal X, Y, and Z axes. The injection unit 110 comprises a flow passage forming section made of a plurality of ceramic sheets 110a to 110e layered in order and stuck by pressure, and a pressurizing section made of piezoelectric/electrostrictive elements 110f fixed onto the exterior surface of the ceramic sheet 110f, as in FIG. 32 showing a plan view, and as in FIG. 33 showing a sectional view of the injection unit 110 taken along line 7-7 of FIG. 32.

This injection unit 110 also comprises therein, as a liquid supply system, a liquid supply passage 110-1, a plurality of chambers 110-2 (herein, four lines, each of the lines including 9 chambers, resulting in 36 chambers in total) being mutually independent, a plurality of liquid introduction holes 110-3 having each of the chambers 110-2 communicate with the liquid supply passage 110-1, a plurality of liquid ejection nozzles 110-4 having each one end substantially exposed to the liquid injection space to have each of the chambers 110-2 communicate with the outer portion of the injection unit 110, and a liquid fill port 110-5 to which the liquid eject port of the injector 52 for injecting fuel is coupled.

In a configuration of this liquid supply system, the liquid fill port 110-5 is provided at only one place in the central part in the Y axis direction. The liquid supply passage 110-1 communicating with the liquid fill port 110-5 extends to both sides in the Y axis direction and then branches out into four passages extending in the X axis direction. Each branch line extending in the X axis direction of the liquid supply passage 110-1 communicates with the nine chambers 110-2 via the nine liquid introduction holes 110-3. The capacity of the chambers 110-2 is varied by the operation of the piezoelectric/electrostrictive elements 110f.

This injection unit 110 comprises therein, as a gas supply system, a pair of gas supply passages 110-6 provided at each of end portions in Y axis direction, a plurality of chambers 110-7 being mutually independent (herein, two lines are provided, one line having nine chambers, resulting in 18 in total), a plurality of gas introduction holes 110-8 having each of the chambers 110-7 communicate with each of the gas supply passages 110-6, a plurality of air flowing nozzles 110-9 having each one end substantially exposed to the liquid injection space 21 to have each of the chambers 110-7 communicate with the outer portion of the injection unit 110, and a pair of gas fill ports 110-10 to which one end of the air pipe 63 is coupled and each of which communicates with each of the pair of gas supply passages 110-6.

The gas supply passage 110-6 has a structure similar to that of the liquid supply passage 110-1. The gas supply passage 110-6 is a space defined by side wall surfaces in the ceramic sheet 110b forming a cutout having an elongated circular shape whose major and minor axes extend in parallel with X and Y axes directions, respectively, an top surface (upper surface) of the ceramic sheet 110a, and an undersurface (lower surface) of the ceramic sheet 110c. The gas supply passage 110-6 communicates with the compressor 65 via the gas fill port 110-10 formed in ceramic sheets 110c to 110e and via the air pipe 63, and is supplied with the pressurized (compressed) air to be injected when the electromagnetic open-close valve 64 is opened.

Each of the plurality of chambers 110-7 is a space having a longer axis and a shorter axis similar to the chambers 110-2, the space being defined by the side wall surface of a cutout space, formed in the ceramic sheet 110d, of which shape is an elongated circle whose major and minor axes are in parallel with Y axis direction and an X axis direction, respectively, an top surface (upper surface) of the ceramic sheet 110c, and an undersurface (lower surface) of the ceramic sheet 110e. One end of each of the chambers 110-7 extends up to an upper portion of the gas supply passage 110-6, and each of the chambers 110-7 communicate, at the one end, with the gas supply passage 110-6 by means of the hollow cylindrical gas introduction hole 110-8 which is formed in the ceramic sheet 110c.

Each of the air nozzles 110-9 is a hollow cylindrical through-hole which is provided in the ceramic sheets 110a to 110c and has an axial line in the Z axis direction, and has a gas injection opening 110-9a at one end substantially exposed to the liquid injection space 21, thereby having the chamber 110-7 communicates with the liquid injection space.

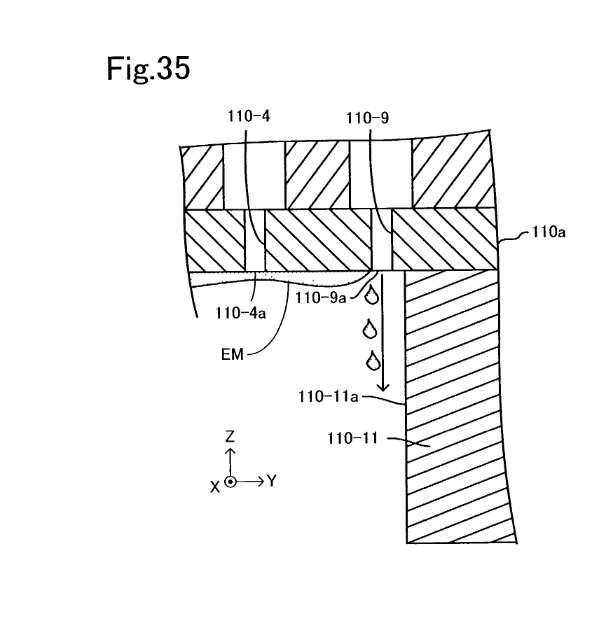

The injection unit 110 further comprises a pair of air current direction control wall sections 110-11 which is in the lower portion (Z axis negative direction) of the ceramic sheet 110a and at both ends in Y axis direction. Each of air current direction control wall sections 110-11 has a rectangular parallelepiped shape whose sides extends in parallel with the X, Y and Z axes directions, respectively and its top surface (surface parallel to the X-Y plane) is bonded to the undersurface of the ceramic sheet 110a. A pair of wall surfaces (air current direction control wall surface) 110-11a, 110-11a, parallel to the X-Z plane, of the air current direction control walls 110-11 are opposed to each other. Each of the air current direction control wall surfaces 110-11a, 110-11a is built at the position outside in the Y axis direction apart from each of the gas injection openings 110-9a and 110-9a with a some distance, as in FIG. 35 showing enlarged view. The gas injection openings 110-9a and 110-9a are positioned at both ends in the Y direction of the injection unit 110.

With the configuration described above, the injection unit 110 comprises nine liquid injection openings and nine gas injection openings per each line extending in the X axis direction on the undersurface (lowerplane) of the injection unit 110. In the injection unit 110, a line of gas injection openings, four lines of liquid injection openings and a line of gas injection openings are positioned in order from the end portion of the Y axis negative direction side to the Y axis positive direction side.

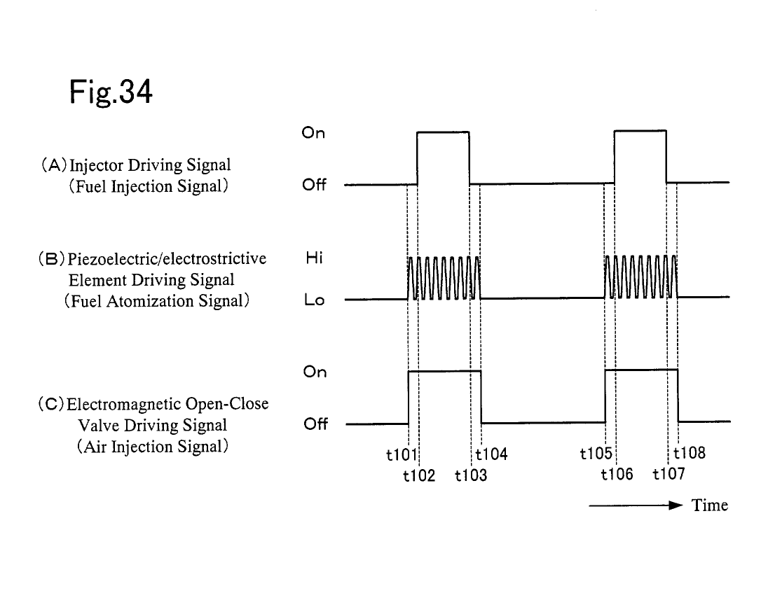

In this injection unit 110, an injector driving signal, a piezoelectric/electrostrictive element driving signal and an electromagnetic open-close valve driving signal, shown in FIG. 34, are provided to the injector 52, each of the piezoelectric/electrostrictive elements 110f and the electromagnetic open-close valve 64, respectively, from the electric control device (not shown). The electric control device inputs engine operation states such as an engine rotation speed N and suction pipe pressure P to perform a necessary calculation, and outputs each of the driving signals mentioned above.

The operation of the liquid injection apparatus in accordance with the tenth embodiment will then be described. The electric control device (injection control means) not only determines the injector driving signal (length of a high level signal) on the basis of the engine operation states such as the engine rotation speed N and the suction pipe pressure P, but also determines the timing (the timing t102 in FIG. 34) to output the injector driving signal. The electric control device starts giving (sending) the piezoelectric/electrostrictive element driving signal having a frequency f across the electrodes of the piezoelectric/electrostrictive elements 110f at the timing t101 prior to the timing t102 by predetermined time period, and changes the electromagnetic open-close valve driving signal from “OFF” to “ON” (high level). These signals start changing the capacity of the chamber 110-2, and as shown by arrows in FIG. 33 and FIG. 35, injecting air from each of the air injection ports l(gas injection openings) 10-9a, thereby an air current begins to be generated. The air current goes along the surfaces 110-11a of the air current direction control wall 110-11 in the Z axis negative direction.

The electric control device then changes the injector driving signal from “OFF” to “ON” (high level) at the timing t102 slightly after the timing t101. As a result, since the needle valve (not shown) of the injector 52 is moved, fuel starts being ejected and supplied to the liquid supply passage 110-1 via the liquid fill port 110-5 of the injection unit 110, and then starts flowing into the chamber 110-2 via the liquid introduction hole 110-3. When the pressure of the fuel in the chamber 110-2 rises to an adequate pressure, the fuel is pressed out (injected) towards the liquid injection space in the suction pipe 61 from the liquid injection opening of the liquid ejection nozzle 110-4. At this point, since vibration energy by the operation of the piezoelectric/electrostrictive elements 110f is added to the fuel in the chamber 110-2, a constriction is generated in the pressed out fuel, and the end portion of the fuel breaks away at (from) the constriction as if it is torn off. As a result, the fuel is injected as particles uniformly and finely atomized.

The electric control device then changes the injector driving signal from “ON” to “OFF” (low level) at the timing t103. As a result, since the needle valve of the injector 52 is returned to an initial position, the eject and supply of fuel are stopped, and the fuel injection from the fuel ejection nozzles 110-4 is stopped. The electric control device then stops giving the piezoelectric/electrostrictive element driving signal and changes the electromagnetic open-close valve driving signal for the electromagnetic open-close valve 64 from “ON” to “OFF” (low level) at the timing t104 which is slightly after the timing t103 to stop the air injection (gas injection) from the air flowing nozzles 110-9. After that, the electric control device performs similar fuel injection control repeatedly as indicated from the timing t105 to t108 in FIG. 34.

In this way, in the liquid injection apparatus in accordance with the tenth embodiment, because air is injected into the liquid injection space from the liquid injection opening during the fuel is being injected (i.e., fuel injection and air injection are carried out substantially synchronously) to generate the air current in a predetermined direction (direction substantially parallel to the main axis direction of the fuel injection) during the fuel injection, fuel liquid droplets which are atomized and does not have the inclination to move straight are transported to a desired position in the liquid injection space on and by the air current. This prevents the atomized liquid droplets from drifting (remaining) at the same position to be recombined (joined together). Thus, it is possible to prevent the particle diameter of the liquid droplets from becoming larger. Accordingly, the amount of fuel sticking or adhering onto the wall surface of the suction pipe 61 decreases, thereby fuel consumption of the internal combustion engine can be improved and the amount of the undesirable exhaust gas from the internal combustion engine can be reduced more effectively.

Furthermore, in the present embodiment, air injection from the gas injection opening is started at the timingt 101 prior to the timing t102 when fuel injection is started, and the air injection is continued until the timing t104 later than the timing t103 when the fuel injection is stopped. As a result, as illustrated in FIG. 35 showing a partially enlarged view of the vicinities of the gas injection opening of the injection unit 110, it is possible to reduce the amount of liquid film EM remaining and sticking (adhering) on the wall surface (undersurface of the ceramic sheet 110a) in the vicinity of the liquid injection opening 110-4a at the timing of stopping the fuel injection, and moreover, the liquid film EM can be removed before next fuel injection since the liquid film EM can be atomized (removed) by the air current. As a result, it is possible to certainly form the fuel into fine particles when the fuel injection is started, and to avoid liquid droplets having a large particle diameter due to the liquid film EM. Thus, it is possible to reduce the amount of the undesirable exhaust gas from the internal combustion engine.

In addition, in the present embodiment, the air current direction control wall surfaces 110-11a of the air current direction control wall sections 110-11 are provided, and air is injected from a position near the air current direction control wall surfaces 110-11a, so that the main components (current) of the air current can be brought into about the same direction (in this case, the air current proceeds mainly along Z axis negative direction). Therefore, it is possible to certainly transport the injected liquid droplets to the predetermined position (the desired region). It is also possible to prevent the injected liquid droplets from adhering onto the air current direction control wall surfaces 110-11a, since the gas injection opening is disposed between the air current direction control wall surface 110-11a and the liquid injection opening (i.e. between the liquid injection opening and the nodal line which is defined by the air current direction control wall surfaces 110-11a and the undersurface of the injection unit 110 on which the fuel injection openings 110-4a are formed).

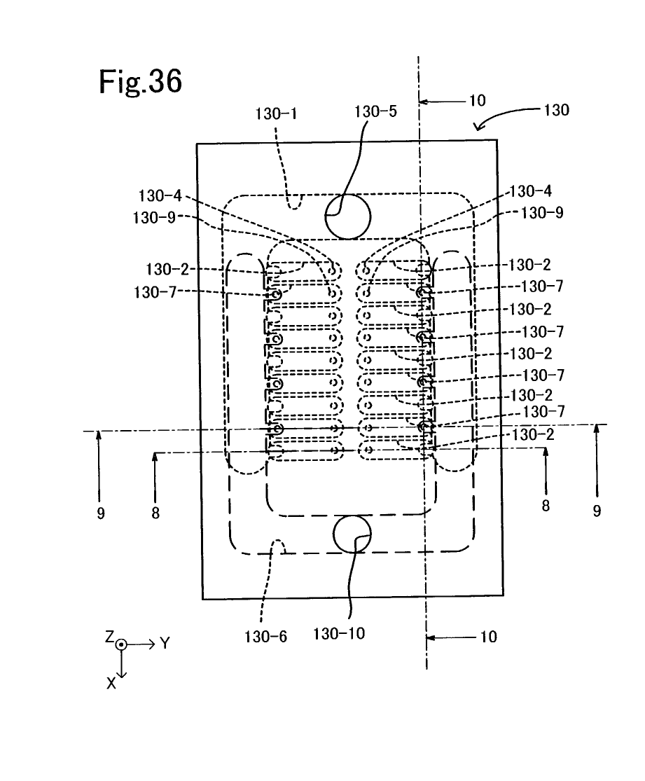

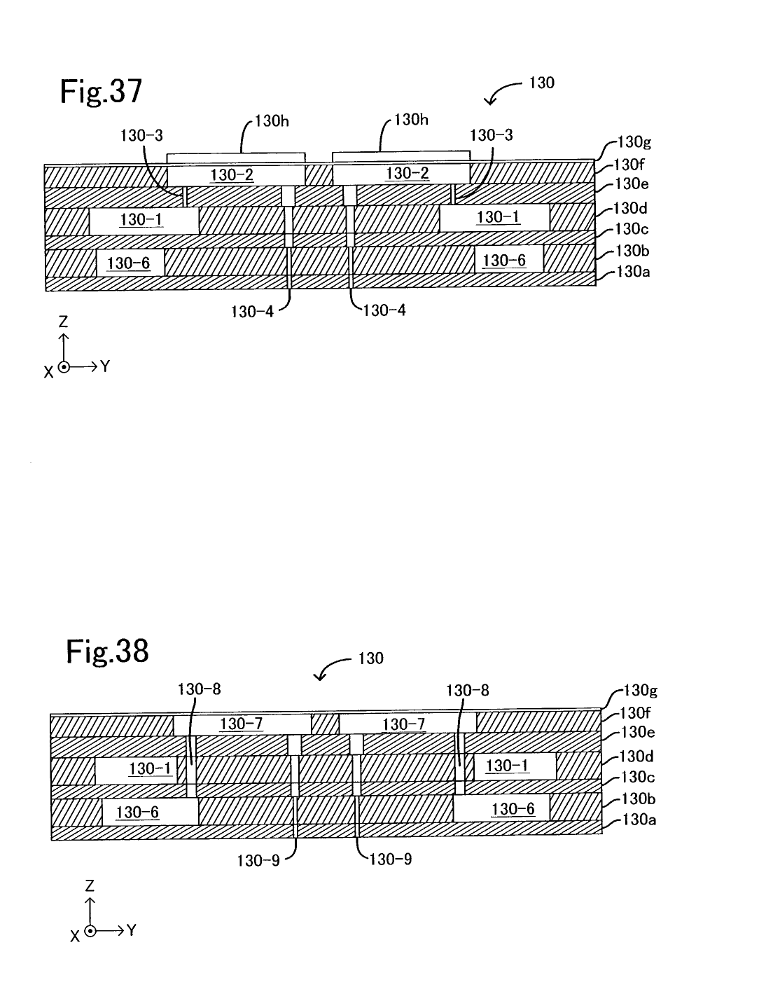

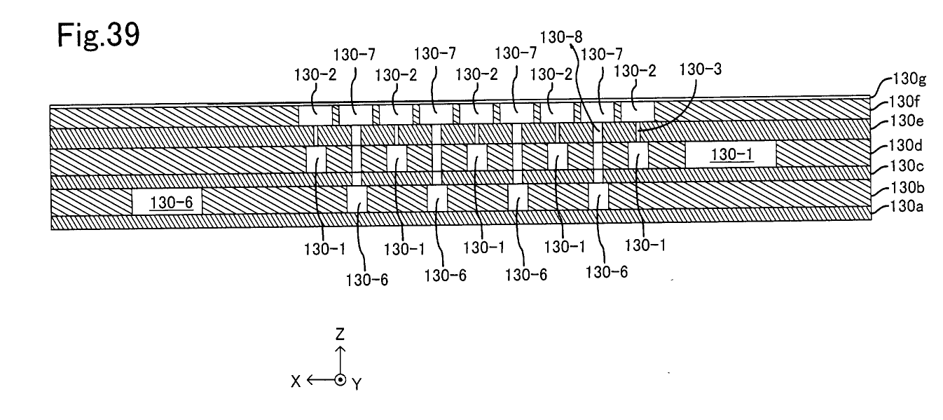

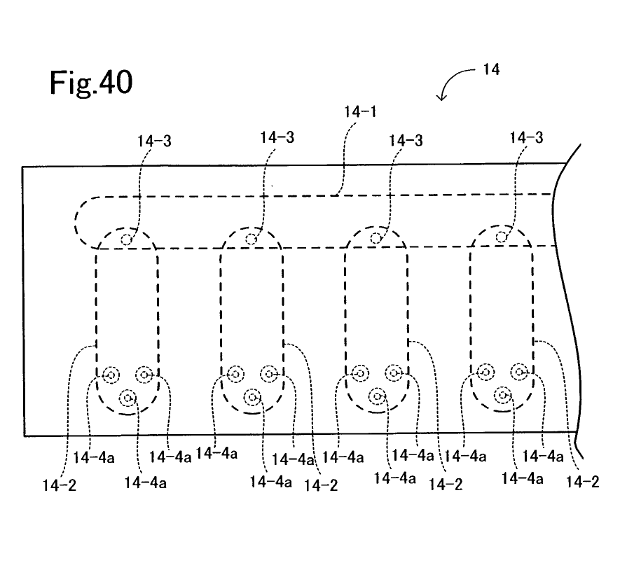

A liquid injection apparatus in accordance with an eleventh embodiment of the present invention will then be described. This liquid injection apparatus is different from that of the tenth embodiment mainly in that it adopts an injection unit 130 shown in FIG. 36 to FIG. 39, in place of the injection unit 110 used in the tenth embodiment. Therefore, hereinafter, description will be made with focusing on this difference. FIG. 36 shows a plan view of the injection unit 130, and FIG. 37 to FIG. 39 show sectional views of the injection unit 130 taken along line 8-8, line 9-9 and line 10-10 of FIG. 36, respectively.

This injection unit 130 injects air together with fuel, similarly to the injection unit 110. However, the injection unit 130 is different from the injection unit 110 in that the liquid injection opening and the gas injection opening are arranged alternately in one line (line along the X axis) on the undersurface of the injection unit 130.

More specifically, the injection unit 130 has a substantially rectangular parallelepiped shape whose sides extend in parallel with orthogonal X, Y and Z axes, and comprises a flow passage forming section made of a plurality of ceramic sheets 130a to 130g layered and stuck by pressure in order, and a pressurizing section made of piezoelectric/electrostrictive elements 130h fixed onto the exterior surface (plane parallel to the X-Y plane in the Z axis direction) of the ceramic sheet 130g.

This injection unit 130 comprises therein, as a liquid supply system, a liquid supply passage 130-1, a plurality of liquid pressurizing chambers 130-2 (herein, two lines, each of the lines including five, resulting in 10 in total) being mutually independent, a plurality of liquid introduction holes 130-3 having each of the chambers 130-2 communicate with the liquid supply passage 130-1, a plurality of liquid ejection nozzles 130-4 having each one end substantially exposed to the liquid injection space to have each of the chambers 130-2 communicate with the outer portion of the injection unit 130, and a liquid fill port 130-5 to which the liquid eject port of the injector 52 for injecting fuel is coupled.

The liquid supply passage 130-1 is a space defined by side walls forming hollow space in the ceramic sheet 130d, an undersurface of the ceramic sheet 130e, and an top surface of the ceramic sheet 130c. The chamber 130-2 is a space defined 130f, an undersurface of the ceramic sheet 130g and an top surface of the ceramic sheet 130e. The liquid introduction hole 130-3 is a hollow cylindrical space to penetrate the ceramic sheet 130e to have the liquid supply passage 130-1 communicate with the chambers 130-2. The liquid ejection nozzle 130-4 is a hollow cylindrical through-hole formed in the ceramic sheets 130a to 130e to have the chambers 130-2 communicate with the outside of the injection unit 130 via the liquid injection opening formed in the sheet 130a.

In a configuration of this liquid supply system, only one liquid fill port 130-5 is provided at the central portion in the Y axis direction and in the vicinity of end portion of X axis negative direction. The liquid supply passage 130-1 communicating with the liquid fill port 130-5 extends to both outer directions along Y axis, and further extends in the X axis positive direction from the portion extending in the outer directions to form a pair (two lines) of liquid supply passages 130-1. Each of the five liquid pressurizing chambers 130-2 communicates with one line of the liquid supply passages 130-1 via the five liquid introduction holes 130-3. Further, the capacity of the chamber 130-2 is varied by the operation of the piezoelectric/electrostrictive elements 130h.

This injection unit 130 comprises therein, as a gas supply system, a gas supply passage 130-6, a plurality of gas chambers 130-7 being mutually independent (herein, two lines are provided, one line having four chambers, resulting in eight in total), a plurality of gas introduction holes 130-8 having each of the chambers 130-7 communicate with each of the gas supply passages 130-6, a plurality of air nozzles (gas ejection nozzles) 130-9 having each one end substantially exposed to the liquid injection space to have each of the chambers 130-7 communicate with the outer portion of the injection unit 130, and a gas fill port 130-10 to which one end of the air pipe 63 shown in FIG. 31 is coupled and which communicates with the gas supply passage 130-6.

The gas supply passage 130-6 is a space defined by side walls forming hollow space in the ceramic sheet 130b, an undersurface of the ceramic sheet 130c, and an top surface of the ceramic sheet 130a. The chamber 130-7 is a space by side walls of a hollow formed in the ceramic sheet 130f, an undersurface of the ceramic sheet 130g, and an top surface of the ceramic sheet 130e. The gas introduction hole 130-8 is a hollow cylindrical space to penetrate the ceramic sheets 130c to 130e for having the gas supply passage 130-6 communicate with the chambers 130-7. The air nozzle 130-9 is a hollow cylindrical through-hole formed in the ceramic sheets 130a to 130e and whose axial line extends in Z axis direction to have the chambers 130-7 communicate with the outside of the injection unit 130 via the gas injection opening formed in the sheet 130a.

In a configuration of this gas supply system, only one gas fill port 130-10 is provided at the central portion in the Y axis direction and in the vicinity of end portion of X axis positive direction. The gas supply passage 130-6 communicating with gas fill port 130-10 extends to both outer directions along Y axis, and further extends in the X axis negative direction from the portion extending in the outer directions to form a pair (two lines) of gas supply passages. Each of the four gas chambers 130-7 communicates with one line of the gas supply passages 130-6 via the four gas introduction holes 130-8.

In this injection unit 130 also, similarly to the injection unit 110, the injector driving signal, the piezoelectric/electrostrictive element driving signal and an electromagnetic open-close valve driving signal as shown in FIG. 34 are provided to the injector 52, each of the piezoelectric/electrostrictive elements 130h and the electromagnetic open-close valve 64, respectively, from the electric control device not shown.

Therefore, in this injection unit, liquid droplets atomized by the capacity change of the chamber 130-2 and injected are transported on and by the air current to the predetermined position, because the fuel injection and the air injection are performed synchronously. This prevents the atomized liquid droplets from drifting (remaining) at the same position. Thus, it is possible to prevent the particle diameter of the liquid droplets from becoming larger. Accordingly, the amount of fuel sticking or adhering onto the wall surface of the suction pipe 61 decreases, thereby fuel consumption of the internal combustion engine can be improved and the amount of the undesirable exhaust gas from the internal combustion engine can be reduced more effectively.

Furthermore, in the present liquid injection apparatus, because the air current is being generated before and after fuel injection, it is possible to reduce the amount of liquid film remaining and sticking (adhering) onto the wall surface (undersurface of the ceramic sheet 130a) in the vicinity of the liquid injection opening, and it is also possible to atomize and remove the liquid film by the air current before next fuel injection. As a result, the fuel can certainly be atomized when the fuel injection is started, and it is possible to avoid liquid droplets having a large particle diameter due to the liquid film. Thus, it is possible to reduce the amount of the undesirable exhaust gas from the internal combustion engine.

In addition, in the present liquid injection apparatus, since the liquid injection openings of the nozzle 130-4 and the gas injection openings of the nozzle 130-9 are arranged alternately, the injected liquid droplets can easily be transported by the air current, thereby it is possible to reduce the amount of recombining of the injected liquid. It is also possible to remove the liquid film in the vicinity of the liquid injection opening by the air current easily (because of the alternate arrangement of the liquid injection openings and the gas injection openings).

Moreover, in the tenth embodiment and the eleventh embodiment in which air is injected together with fuel, it is likely that the injected liquid droplets are made to move straight, since each main axis of the fuel injection direction and the air injection direction is in the same direction (herein, Z axis negative direction) and in a direction parallel to each other. Therefore, the liquid droplets can easily be made to reach a desired place (region).

Still further, in the tenth embodiment and the eleventh embodiment, it is preferable that the injection speed of air is designed to be higher than the injection speed of fuel. This can be accomplished by, for example, adjusting the compressive force of the air compressor. The reason why this is preferable is that, the injected air current can not overcome the air current generated by the injected liquid droplets, if the injection speed of air is lower than the injection speed of fuel, which makes it impossible to transport the liquid droplets to the desired place (region).

It is noted that, in the tenth embodiment and the eleventh embodiment, although air is injected by using the compressor 65, the configuration (composition) may be such that, as indicated with dashed lines in FIG. 31, the other end of the air pipe 63 is made to communicate with the suction pipe 61 at upstream of a throttle valve 66 of the internal combustion engine, and air is injected from the injection units 110 and 130 by the differential pressure between upstream and downstream of the throttle valve 66. In this configuration, the electromagnetic open-close valve 64 may be omitted. It is also possible to have a configuration in which the other end of the air pipe 63 is opened to the atmosphere so that the air is injected by the differential pressure between atmosphere pressure and negative pressure downstream of the throttle valve. As apparent from these description, the cost of the entire liquid injection apparatus can be reduced, since an expensive pressure applying means such as the compressor 65 can be omitted.

In addition, the structure (air assist structure) of the injection units 110 and 130 described in the tenth embodiment and the eleventh embodiment is applicable not only to what is called a pressurizing method, in which the liquid (fuel) is pressurized by the pressurizing means such as the pressurizing pump 11 to be injected, but also to, for example, a liquid injection apparatus utilizing what is called “differential pressure control pipe method” as shown in Japanese Patent Application Laid-open No. 2000-15081, or to an ink jet type apparatus that generates pressure for injecting fuel only by the capacity change (displacement) of the chambers caused by the operation of the piezoelectric/electrostrictive element.

As described above, according to the liquid injection apparatus in accordance with each of the embodiments of the present invention, it is possible to stably inject liquid (gasoline) uniformly atomized, regardless of environment surrounding the liquid injection apparatus (e.g. the operation state of the engine). Further, according to the embodiments described above, it is possible to inject fuel with maintaining a favorable atomization state as required, regardless of the air flow velocity in the suction pipe (intake pipe), whereas, in conventional carburetors, the flow volume of fuel (liquid) is determined in accordance with air flow velocity in the space inside the suction pipe that is corresponding to the liquid droplet eject space, and the degree of atomization is changed depending upon the air flow velocity. In addition, some of the liquid injection apparatus in accordance with the present invention does not require a compressor for supplying assist air, thereby making the apparatus inexpensive, unlike a conventional apparatuses that requires the compressor to supply assist air to a nozzle section of a injector for prompting atomization of the fuel.

Furthermore, in the liquid injection apparatus in accordance with the present invention, it is preferable that the liquid to be injected (sprayed) be petroleum carbon hydride such as gasoline or kerosene, or synthetic carbon hydride. This is because, it is less likely that air bubbles remain inside the flow passage and become larger since the injection unit (flow passage forming section of the injection unit) in the liquid injection apparatus has a good wettability with such liquid if the injection unit is made of ceramics. Further, it is especially preferable that the density of the liquid to be injected by the present liquid injection apparatus be 1 g/cm³ or less, and its viscosity be from 0.5 to 1.0 mPa.s. Because it is not necessary to increase excessively the capacity variation ΔV of the chamber 14-2 caused by the piezoelectric/electrostrictive element in order to inject liquid droplets in a favorable atomization state, if the liquid to be injected is the liquid having such density mentioned above. Also because, if the injected liquid is the liquid having that viscosity, the ejected liquid can separate easily at its end portion as shown in FIG. 6A, and atomization can easily accomplished.

The present invention is not limited to the above embodiments, and could variously be modified without departing from the scope and sprit of the present invention. For example, in the third embodiment, one end of the second liquid supply pipe 42 is connected to the ejection section 43b of the pressurizing pump 43, however, this one end may be connected to the portion 12a of the first liquid supply pipe 12 between the ejection section 43b of the pressurizing pump 43 and the regulator 46, and the second liquid supply pipe 42 branches from this portion to be connected to the liquid passage 41b of the injection valve 41. Further, whereas the liquid injection apparatus in the above embodiments is applied to the internal combustion engine, it can be applied to other mechanical apparatuses that makes material with liquid droplets of liquid material atomized. Further, the piezoelectric/electrostrictive element 17 may be a common element (single element) to a plurality of pressurizing chambers as long as it can increase the liquid pressure in the pressurizing chambers.

Furthermore, as the injection unit of the liquid injection apparatus whose enlarged partial plan view is shown in FIG. 40, a plurality of liquid injection openings (eject holes) 14-4a may be provided to one chamber 14-2. With this configuration, it is possible to inject a large amount of liquid droplets having a uniform and minute particle diameter at one time, without changing the size of the injection unit.

Still further, a liquid-repellent-treated layer may be provided to surround the liquid injection opening 14-4a. The liquid-repellent-treated layer can be made of a fluorocarbon resin or the like outside (undersurface side) the ceramic sheet 14a, and may be formed, for example, in a ring shape, to surround the liquid injection opening 14-4a (For more detail, refer to Patent Application No. 2000-185494 filed by the same applicant (assignee)). With these configuration, since the liquid-repellent-treated layer is provided around the liquid injection opening 14-4a, the ejected liquid droplets are difficult to stick or adhere to the vicinity of the eject nozzle. Therefore, liquid is unlikely to remain in the vicinity of the liquid injection opening 14-4a at the end of the liquid injection, and it can be avoided for the remaining liquid to be ejected at the next start of the liquid injection, thereby making it possible to constantly keep the particle diameter of the injected liquid uniform.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A liquid injection apparatus comprising:
an injection unit which comprises a flow passage forming section, the flow passage forming section including a liquid ejection nozzle having one end exposed to a liquid injection space and a chamber which communicates with the other end of the liquid ejection nozzle and with one end of a first liquid supply pipe;
drive voltage generating means for generating a drive voltage signal having a predetermined frequency; and
pressurizing means having an ejection section to which is connected the other end of the first liquid supply pipe, the pressurizing means having an introduction section in communication with a liquid storage tank, the pressurizing means pressurizing liquid introduced through the introduction section from the liquid storage tank to eject the liquid from the ejection section, to thereby inject the liquid into the liquid injection space through the liquid ejection nozzle of the liquid injection unit;
wherein the injection unit comprises a plurality of the liquid ejection nozzles, the injection unit having a pressurizing section which includes a piezoelectric/electrostrictive element positioned at part of a wall surface of the chamber for changing the capacity of the chamber, the piezoelectric/electrostrictive element being actuated by the drive voltage signal from the drive voltage generating means to atomize the liquid injected from the liquid ejection nozzle.

2. The liquid injection apparatus according to claim 1, further comprising:
an injection valve including a liquid injection opening exposed to the liquid injection space, a liquid passage communicating with the liquid injection opening, and an electromagnetic valve for opening and closing the liquid passage; and
a second liquid supply pipe for placing the liquid passage of the injection valve in communication with the ejection section of the pressurizing means.

3. The liquid injection apparatus according to claim 2, further comprising:
a regulator which is interposed in the first liquid supply pipe, for reducing the pressure of liquid generated by the pressurizing means.

4. The liquid injection apparatus according to claim 1, wherein
the ratio of the capacity of the chamber to the variation of the capacity of the chamber caused by the operation of the piezoelectric/electrostrictive element is a value ranging from 2 to 3000 inclusive.

5. The liquid injection apparatus according to claim 1, wherein
the chamber includes a flow passage section through which the liquid flows from the side of the first liquid supply pipe toward the side of the liquid ejection nozzle, the shape of a section of the flow passage section taken
along a plane orthogonal to the direction of flow of the liquid is being substantially rectangular, and wherein
the piezoelectric/electrostrictive element is fixed in at least a part of the wall surface of the chamber that includes at least one side of the rectangle, with the ratio of the length of a side orthogonal to the one side to the length of the one side being less than 1.

6. The liquid injection apparatus according to claim 1, wherein
the chamber includes:
a flow passage section which communicates, at one end portion, with one end of the first liquid supply pipe via a liquid introduction hole, the flow passage section being connected, at the other end portion, to the other end of the liquid ejection nozzle, such that the liquid flows from the one end portion toward the other end portion, and wherein
the area of the section of the flow passage section taken along the plane orthogonal to the direction of flow of the liquid is larger than the cross section area of the liquid introduction hole and than the cross section area at one end exposed to the liquid injection space of the liquid ejection nozzle.

7. The liquid injection apparatus according to claim 6, wherein
the cross section area at one end exposed to the liquid injection space of the liquid ejection nozzle is larger than the cross section area of the liquid introduction hole.

8. The liquid injection apparatus according to claim 1, wherein
the injection unit comprising an electromagnetic open-close valve having a liquid passage and an electromagnetic valve for opening and closing the liquid passage, the electromagnetic open-close valve being disposed to place one end of the first liquid supply pipe in communication with the chamber by way of the liquid passage; and wherein
the liquid is injected from the liquid ejection nozzle when the electromagnetic valve of the electromagnetic open-close valve is opened.

9. The liquid injection apparatus according to claim 1, further comprising:
an electromagnetic open-close valve which is interposed in the first liquid supply pipe, for opening and closing the flow passage of the fist liquid supply pipe; and
a bypass pipe which provides communication the liquid storage tank with the fist liquid supply pipe at between the electromagnetic open-close valve of the fist liquid supply pipe and the ejection section of the pressurizing means, in parallel with the pressurizing means, the bypass pipe having a check valve interposed therein for permitting liquid to flow from the fist liquid supply pipe to the liquid storage tank, only when the pressure of the liquid in the fist liquid supply pipe at between the electromagnetic open-close valve and the ejection section of the pressurizing means is beyond a predetermined value.

10. The liquid injection apparatus according to claim 1, wherein
the flow passage forming section of the injection unit is formed of zirconia ceramics; and wherein
the flow passage forming section of the injection unit and the piezoelectric/electrostrictive element of the pressurizing section are integrally formed by burning.

11. The liquid injection apparatus according to claim 1, wherein
the flow passage forming section and the pressurizing section are made as separate members, and the piezoelectric/electrostrictive element of the pressurizing section is bonded to the flow passage forming section.

12. The liquid injection apparatus according to claim 11, wherein
the pressurizing section presses the wall surface of the chamber in the flow passage forming section to change the capacity of the chamber.

13. The liquid injection apparatus according to claim 12, wherein
the pressurizing section includes a plate made of ceramics which has the rigidity higher than that of the chamber wall pressed by the pressurizing section and which is immovably fixed to the flow passage forming section apart a predetermined distance from the wall surface of the chambers; and wherein
the piezoelectric/electrostrictive element is formed in a shape of a thin plate, and at one surface, is integrally joined by burning to the ceramic plate, and at the other surface, is bonded to the chamber wall surface pressed by the pressurizing section.

14. The liquid injection apparatus according to claim 10, wherein
the pressurizing section is comprised of a layer which includes a multiplicity of alternating laminal piezoelectric/electrostrictive elements and laminal electrodes.

15. The liquid injection apparatus according to claim 11, wherein
the pressurizing section is comprised of a layer which includes a multiplicity of alternating laminal piezoelectric/electrostrictive elements and laminal electrodes.

16. The liquid injection apparatus according to claim 1, wherein
the chamber is connected to one end of the first liquid supply pipe via the liquid introduction hole; and wherein
the drive voltage generating means increases the voltage of the drive voltage signal up to a predetermined voltage to decrease the capacity of the chamber so that the pressure of liquid in the chamber and in the liquid introduction hole is increased, then maintains the voltage at the predetermined voltage until the pressure of the liquid in the liquid introduction hole substantially drops down to the pressure generated by the pressurizing means, and then decreases the voltage.

17. The liquid injection apparatus according to claim 1, wherein
a frequency of the drive voltage signal is substantially equal to a resonance frequency of the injection unit.

18. The liquid injection apparatus according to claim 1, wherein
the injection unit comprises a plurality of the chambers, at least one of the plurality of chambers comprising a plurality of liquid ejection nozzles.

19. The liquid injection apparatus according to claim 1, wherein
the shape of the liquid injection opening which is one end of the liquid ejection nozzle exposed to the liquid injection space is a shape having a major axis and a minor axis including a substantial elliptical shape, a substantial oval shape, and a substantial rectangular shape.

20. The liquid injection apparatus according to claim 1, wherein
the injection unit comprises an air nozzle having its one end exposed to the liquid injection space, thereby the injection unit not only injecting liquid via the liquid ejection nozzle but also injecting air via the air nozzle.

21. The liquid injection apparatus according to claim 20, wherein
the one end exposed to the liquid injection space of the liquid ejection nozzle provides a liquid injection opening on the undersurface of the injection unit, the one end of the air nozzle providing a gas injection opening on the undersurface of the injection unit.

22. The liquid injection apparatus according to claim 21, wherein
the injection unit comprises a plurality of the liquid injection openings and a plurality of the gas injection openings, the liquid injection openings and the gas injection openings being alternately arranged.

23. The liquid injection apparatus according to claim 20, further comprising:
injection control means for starting gas injection via the air nozzle before the start of liquid injection via the liquid ejection nozzle, and for stopping the gas injection via the air nozzle after ending of the liquid injection via the liquid ejection nozzle.

24. The liquid injection apparatus according to claim 20, wherein
the injection unit comprises an air current direction control wall for controlling the direction of gas injection by way of the air nozzle.

25. The liquid injection apparatus according to claim 24, wherein
one end of the air nozzle is disposed between one end of the liquid ejection nozzle and the air current direction control wall.

26. The liquid injection apparatus according to claim 20, wherein
the liquid ejection nozzle and the air nozzle inject respectively liquid and gas in parallel with each other.

27. The liquid injection apparatus according to claim 20, wherein
the velocity of the injected liquid is lower than the velocity of the injected gas.

28. A method of adjusting the resonance frequency of an injection unit in a liquid injection apparatus, the liquid injection apparatus having
an injection unit including a liquid ejection nozzle one end of which is exposed to a liquid injection space, a chamber communicating with the other end of the liquid ejection nozzle and one end of a first liquid supply pipe, a lower electrode formed on a wall surface of the chamber, an upper electrode formed opposite to the lower electrode, and a piezoelectric/electrostrictive element formed between the lower electrode and the upper electrode,
drive voltage generating means for providing a drive voltage signal having a predetermined frequency across the upper electrode and the lower electrode to thereby give an electric field to the piezoelectric/electrostrictive element, for causing vibration of the wall of the chamber by actuating the piezoelectric/electrostrictive element, and
pressurizing means having an ejection section to which is connected the other end of the first liquid supply pipe and also having an introduction section communicating with a liquid storage tank, for pressurizing liquid in the liquid storage tank introduced from the introduction section to eject the liquid from the ejection section, to thereby inject the liquid into the liquid injection space via the liquid ejection nozzle of the injection unit,
wherein liquid injected from the liquid ejection nozzle is atomized by the operation of the piezoelectric/electrostrictive element,
characterized in that trimming part of the upper electrode to change a region of the piezoelectric/electrostrictive element to which the electric field is applied by the upper electrode and the lower electrode, and thereby adjusting the resonance frequency of the injection unit to be substantially equal to a frequency in the vicinity of the frequency of the drive voltage signal.
